(19) United States
(12) Patent Application Publication
(10) Pub. No.: US 2016/0174247 A1
(43) Pub. Date: Jun. 16, 2016

(54) TERMINAL APPARATUS, BASE STATION APPARATUS, COMMUNICATION SYSTEM, COMMUNICATION METHOD, AND INTEGRATED CIRCUIT

(71) Applicant: Sharp Kabushiki Kaisha, Osaka-shi, Osaka (JP)

(72) Inventors: Alvaro RUIZ DELGADO, Osaka-shi (JP); Kazuyuki SHIMEZAWA, Osaka-shi (JP); Toshizo NOGAMI, Osaka-shi (JP); Kimihiko IMAMURA, Osaka-shi (JP); Naoki KUSASHIMA, Osaka-shi (JP); Shoichi SUZUKI, Osaka-shi (JP)

(73) Assignee: Sharp Kabushiki Kaisha, Osaka-shi, Osaka (JP)

(21) Appl. No.: 14/910,119

(22) PCT Filed: Aug. 6, 2014
(86) PCT No.: PCT/JP2014/071505

§ 371 Date: Feb. 4, 2016

Related U.S. Application Data
(60) Provisional application No. 61/862,586, filed on Aug. 6, 2013.

(51) Int. Cl. H04W 72/12; H04W 28/18

(52) U.S. Cl. CPC H04W 72/1273; H04W 28/18

(57) ABSTRACT

A base station device transmits common control information to a plurality of mobile station devices through a single ePDCCH message. Each mobile station device monitors a common search space in which these common control messages are sent and is capable of detecting them and recovering the information contained therein.

### TECHNICAL FIELD

The present document describes methods and processes applicable to wireless communication systems, with a focus on enhanced common search space for ePDCCH in LTE.

### BACKGROUND ART

The Third Generation Partnership Project (3GPP) is constantly studying the evolution of the radio access schemes and radio networks for cellular mobile communications (hereinafter referred to as “Long Term Evolution (LTE)” or “Evolved Universal Terrestrial Radio Access (EUTRA)”. In LTE, the Orthogonal Frequency Division Multiplexing (OFDM) scheme, which is a multi-carrier transmission scheme, is used as a communication scheme for wireless communication from a base station device (hereinafter also referred to as “base station apparatus”, “base station”, “eNB”, “access point”) to a mobile station device (herein after also referred to as “mobile station”, “terminal station”, “terminal station apparatus”, “user equipment”, “UE”, “user”). Also, the Single-Carrier Frequency Division Multiple Access (SC-FDMA) scheme, which is a single-carrier transmission scheme, is used as a communication scheme for wireless communication from a mobile station device to a base station device (uplink).

In 3GPP, studies are being performed to allow radio access schemes and radio networks which realize higher-speed data communication using a broader frequency band than that of LTE (hereinafter referred to as “Long Term Evolution-Advanced (LTE-A)” or “Advanced Evolved Universal Terrestrial Radio Access (A-EUTRA)”) to have backward compatibility with LTE. That is, a base station device of LTE-A is capable of simultaneously performing wireless communication with mobile station devices of both LTE-A and LTE, and a mobile station device of LTE-A is capable of performing wireless communication with base station devices of both LTE-A and LTE. The channel structure of LTE-A is the same as that of LTE, and it is described in Non Patent Literature (NPL) 1 and 2.

In LTE, the base station device transmits the control information through the Physical Downlink Control Channel (PDCCH) or the enhanced PDCCH (ePDCCH or EPDCCH). The mobile stations monitor the PDCCH region looking for messages directed to them, more specifically a subspace of that region called “search space”. The search space to monitor for messages specifically addressed to the individual mobile station devices is called User Search Space (USS). The search space to monitor to look for messages addressed to a group of mobile station devices is called Common Search Space (CSS). In the ePDCCH case, the mobile stations monitor a subspace of the ePDCCH region looking for messages specifically addressed to the individual mobile station devices (ePDCCH USS, from now on also referred to as eUSS). The base station device can configure the mobile station devices through the use of Radio Resource Control (RRC) messages, as described in NPL 3.

### CITATION LIST

### Non Patent Literature

NPL 1: 3rd Generation Partnership Project; Technical Specification Group Radio Access Network; Evolved Universal Terrestrial Radio Access (E-UTRA); Physical Channels and Modulation (Release 11), 3GPP TR36. 211 v11. 3. 0. (2013-06) <URL:http://www.3gpp.org/ftp/Specs/html-info/36211.htm>
NPL 2: 3rd Generation Partnership Project; Technical Specification Group Radio Access Network; Evolved Universal Terrestrial Radio Access (E-UTRA); Physical layer procedures (Release 11), 3GPP TR36. 213 v11. 3. 0. (2013-06) <URL:http://www.3gpp.org/ftp/Specs/html-info/36213.htm>
NPL 3: 3rd Generation Partnership Project; Technical Specification Group Radio Access Network; Evolved Universal Terrestrial Radio Access (E-UTRA); Radio Resource Control (RRC) (Release 11), 3GPP TR36. 331 v11. 3. 0. (2013-03) <URL:http://www.3gpp.org/ftp/Specs/html-info/36331.htm>

### Technical Problem

In the related art there is no detailed description of the EPDCCH common search space that the mobile station devices are expected to monitor looking for common messages addressed to a plurality of mobile station devices. Under the current specification, for transmitting common Information to a plurality of mobile stations the base station transmits that information to each one of them in a plurality of messages, which results in unnecessary overhead and poor utilization of the available resources that could lead to an underuse of the communication channel for lack of signalling capabilities.

The present invention has been made in view of the above-described points, and an object thereof is to provide a mobile station device, a base station device, a wireless communication system, a wireless communication method, and an integrated circuit that enables a base station device to transmit common control information to a plurality of mobile stations through the transmission of a single ePDCCH message.

### Solution to Problem

(1) The present invention has been made to solve the above-described problem, and according to one aspect of the present invention, there is provided a mobile station device that communicates with a base station device, wherein the mobile station device monitors either or both of the PDCCH UE-specific and common search space and the EPDCCH UE-specific and common search space for control information addressed to it or to a group it belongs to, and is able to switch from one set of monitoring assumptions to a different set of monitoring assumptions for each subframe in which monitoring is performed.

(2) A mobile station device according to another aspect of the present invention is constituted such that, in the mobile station device above, the sets of monitoring assumptions define the resource element mapping assumption expected by the mobile station device.

(3) A mobile station device according to still another aspect of the present invention is constituted such that, in the mobile station device above, the sets of monitoring assumptions define the quasi co-location assumption expected by the mobile station device.

(4) A mobile station device according to still another aspect of the present invention is constituted such that, in the mobile station device above, the switch between sets of assumptions is performed according to the Uplink-Downlink configuration and an EPDCCH indication transmitted by the base station device, one set of assumptions involving the mobile station device monitoring the EPDCCH search space in subframes for which the EPDCCH indication is active, and another set of assumptions involving the mobile station device monitoring the PDCCH search space in subframes configured for downlink in which the EPDCCH indication is not active.

(5) A mobile station device according to still another aspect of the present invention is constituted such that, in the mobile station device above, the switch between sets of assumptions is performed according to an EPDCCH indication transmitted by the base station and a pair of Uplink-Downlink configuration parameters that signal some subframes as being configurable for either uplink or downlink, one set of assumptions involving the mobile station device monitoring the EPDCCH search space in legacy subframes for which the EPDCCH indication is active, another set of assumptions involving the mobile station device monitoring the EPDCCH search space in non-legacy subframes for which the EPDCCH indication is active, and another set of assumptions involving the mobile station device monitoring the PDCCH search space in subframes configured for downlink in which the EPDCCH indication is not active.

(6) A mobile station device according to still another aspect of the present invention is constituted such that, in the mobile station device above, the switch between sets of assumptions is performed according to the Uplink-Downlink configuration and two EPDCCH indications transmitted by the base station device, one set of assumptions involving the mobile station device monitoring the EPDCCH search space in subframes for which one of the EPDCCH indication is active, another set of assumptions involving the mobile station device monitoring the EPDCCH search space in subframes for which another one of the EPDCCH indication is active, and another set of assumptions involving the mobile station device monitoring the PDCCH search space in subframes configured for downlink ins which neither of the EPDCCH indications are active.

(7) A mobile station device according to still another aspect of the present invention is constituted such that, in the mobile station device above, the switch between sets of assumptions is performed according to a pair of Uplink-Downlink configuration parameters that signal some subframes as being configurable for either uplink or downlink, one set of assumptions involving the mobile station device monitoring the EPDCCH search space in legacy subframes configured for downlink, and another set of assumptions involving the mobile station device monitoring the EPDCCH search space in non-legacy subframes that can be configured for downlink and in which the mobile station device does not have an uplink transmission grant.

(8) A mobile station device according to still another aspect of the present invention is constituted such that, in the mobile station device above, the switch between sets of assumptions is performed according to a pair of Uplink-Downlink configuration parameters that signal some subframes as being configurable for either uplink or downlink, one set of assumptions involving the mobile station device monitoring the PDCCH search space in legacy subframes configured for downlink, and another set of assumptions involving the mobile station device monitoring the PDCCH search space in non-legacy subframes that can be configured for downlink and in which the mobile station device does not have an uplink transmission grant.

(9) According to still another aspect of the present invention, there is provided a base station device that communicates with a mobile station device, wherein the base station device alternates between mapping the control information in the PDCCH common search space or in the ePDCCH common search space to transmit common information to a group of mobile station devices, and is able to switch from one set of mobile station device monitoring assumptions for each subframe.

(10) A base station device according to still another aspect of the present invention is constituted such that, in the base station device above, the sets of mobile station device monitoring assumptions define the resource element mapping assumption to be expected by the mobile station device.

(11) A base station device according to still another aspect of the present invention is constituted such that, in the base station device above, the sets of mobile station device monitoring assumptions define the quasi co-location assumption to be expected by the mobile station device.

(12) A base station device according to still another aspect of the present invention is constituted such that the base station device above transmits an Uplink-Downlink configuration indication, transmits an EPDCCH indication, the switch between sets of assumptions being performed according to the Uplink-Downlink configuration and the EPDCCH indication, one set of assumptions involving the mobile station device monitoring the EPDCCH search space in subframes for which the EPDCCH indication is active, and another set of assumptions involving the mobile station device monitoring the PDCCH search space in subframes configured for downlink in which the EPDCCH indication is not active.

(13) A base station device according to still another aspect of the present invention is constituted such that the base station device above transmits a pair of Uplink-Downlink configuration indications that signal some subframes as being configurable for either uplink or downlink, transmits an EPDCCH indication, the switch between sets of assumptions being performed according to the Uplink-Downlink configuration and the EPDCCH indication, one set of assumptions involving the mobile station device monitoring the EPDCCH search space in legacy subframes for which the EPDCCH indication is active, another set of assumptions involving the mobile station device monitoring the EPDCCH search space in non-legacy subframes for which the EPDCCH indication is active, and another set of assumptions involving the mobile station device monitoring the PDCCH search space in subframes configured for downlink in which the EPDCCH indication is not active.

(14) A base station device according to still another aspect of the present invention is constituted such that the base station device above transmits an Uplink-Downlink configuration indication, transmits two EPDCCH indication, the switch between sets of assumptions being performed according to the Uplink-Downlink configuration and the two EPDCCH indications, one set of assumptions involving the mobile station device monitoring the EPDCCH search space in subframes for which one of the EPDCCH indication is active, another set of assumptions involving the mobile station device monitoring the EPDCCH search space in subframes for which another one of the EPDCCH indication is active, and another set of assumptions involving the mobile station device monitoring the PDCCH search space in subframes configured for downlink in which neither of the EPDCCH indications are active.

(15) A base station device according to still another aspect of the present invention is constituted such that the base station device above transmits a pair of Uplink-Downlink configuration indications that signal some subframes as being configurable for either uplink or downlink, the switch between sets of assumptions being performed according to the Uplink-Downlink configuration, one set of assumptions involving the mobile station device monitoring the EPDCCH search space in legacy subframes configured for downlink, and another set of assumptions involving the mobile station device monitoring the EPDCCH search space in non-legacy subframes that can be configured for downlink and in which the mobile station device does not have an uplink transmission grant.

(16) A base station device according to still another aspect of the present invention is constituted such that the base station device above transmits a pair of Uplink-Downlink configuration indications that signal some subframes as being configurable for either uplink or downlink, the switch between sets of assumptions being performed according to the Uplink-Downlink configuration, one set of assumptions involving the mobile station device monitoring the PDCCH search space in legacy subframes configured for downlink, and another set of assumptions involving the mobile station device monitoring the PDCCH search space in non-legacy subframes that can be configured for downlink and in which the mobile station device does not have an uplink transmission grant.

(17) According to still another aspect of the present invention, there is provided a communication system in which a base station device and a mobile station device communicate with each other, wherein the base station device alternates between mapping the control information in the PDCCH common search space or in the ePDCCH common search space to transmit common information to a group of mobile station devices, and is able to switch from one set of mobile station device monitoring assumptions for each subframe, and the mobile station device monitors either or both of the PDCCH UE-specific and common search space and the EPDCCH UE-specific and common search space for control information addressed to it or to a group it belongs to, and is able to switch from one set of monitoring assumptions to a different set of monitoring assumptions for each subframe in which monitoring, is performed.

(18) According to still another aspect of the present invention, there is provided a communication method for a mobile station device communicating with a base station device, the communication method comprising a step of monitoring either or both of the PDCCH UE-specific and common search space and the EPDCCH UE-specific and common search space for control information addressed to it or to a group it belongs to, and switching from one set of monitoring assumptions to a different set of monitoring assumptions for each subframe in which monitoring is performed.

(19) According to still another aspect of the present invention, there is provided a communication method for a base station device communicating with a mobile station device, the communication method comprising a step of alternating between mapping the control information in the PDCCH common search space or in the ePDCCH common search space to transmit common information to a group of mobile station devices, and switching from one set of mobile station device monitoring assumptions for each subframe.

(20) According to still another aspect of the present invention, there is provided an integrated circuit for a mobile station device communicating with a base station device, wherein the integrated circuit has a function of monitoring either or both of the PDCCH UE-specific and common search space and the EPDCCH UE-specific and common search space for control information addressed to it or to a group it belongs to, and switching from one set of monitoring assumptions to a different set of monitoring assumptions for each subframe in which monitoring is performed.

(21) According to still another aspect of the present invention, there is provided an integrated circuit for a base station device communicating with a mobile station device, wherein the integrated circuit has a function of alternating between mapping the control information in the PDCCH common search space or in the ePDCCH common search space to transmit common information to a group of mobile station devices, and a function of switching from one set of mobile station device monitoring assumptions for each subframe.

### Advantageous Effects of Invention

According to the present invention, a base station device is capable of transmitting common control information to a plurality of mobile station devices through a single ePDCCH message.

### BRIEF DESCRIPTION OF DRAWINGS

FIG. 1 is a conceptual diagram of a wireless communication system according to the present invention.

FIG. 2 is a diagram illustrating an example of an OFDM structure construction according to the present invention.

FIG. 3 is a diagram illustrating an example of a legacy physical resource block with some of its defined reference signals according to the present invention.

FIG. 4 is a diagram illustrating an example of a non-legacy subframe physical resource block with some of its defined reference signals according to the present invention.

FIG. 5 is a diagram illustrating an example of mobile station device composition according to the present invention.

FIG. 6 is a diagram illustrating an example of base station device composition according to the present invention.

FIG. 7 is a diagram illustrating an example of the configuration of radio frames in a TDD wireless communication system according to the present invention.

FIG. 8 is a table illustrating the uplink-downlink configurations that are possible in a TDD wireless communication system according to the present invention.

FIG. 9 is a diagram illustrating an example of indication of flexible subframes according to the present invention.

FIG. 10 is a table illustrating an example of UE-specific and common search space configuration for PDCCH in a wireless communication system according to the present invention.

FIG. 11 is a diagram illustrating an example of mapping of a physical EPDCCH-PRB-set to its logical ECCEs according to the present invention.

FIG. 12 is a table illustrating an example of UE-specific search space configuration for ePDCCH in a wireless communication system according to the present invention.

FIG. 13 is a diagram illustrating an example of EPDCCH common search space for a wireless communication system according to the present invention.

FIG. 14 is a diagram illustrating an example of EPDCCH-PRB-set assignment to physical resource block in a wireless communication system according to the present invention.

FIG. 15 is a flow chart diagram describing the process by which a mobile station device educes the resource element mapping assumption to be applied to the search space according to the present invention.

FIG. 16 is a flow chart diagram describing the process by which a mobile station device educes the quasi co-location assumption to be applied to the search space according to the present invention.

FIG. 17 is a diagram illustrating an example of EPDCCH explicit indication and search space assumptions by the mobile station device according to the present invention.

FIG. 18 is a diagram illustrating an example of EPDCCH explicit indication and search space assumptions by the mobile station device according to the present invention.

FIG. 19 is a diagram illustrating an example of EPDCCH explicit indication and search space assumptions by the mobile station device according to the present invention.

FIG. 20 is a diagram illustrating an example of EPDCCH implicit indication and search space assumptions by the mobile station device according to the present invention.

FIG. 21 is a diagram illustrating an example of EPDCCH implicit indication and search space assumptions by the mobile station device according to the present invention.

FIG. 22 is a diagram illustrating an example of an RRC message EPDCCH-Config-r12 according to the present invention.

FIG. 23 is a diagram illustrating an example of multiple bitmaps transmitted to the mobile station devices by the base station device according to the present invention.

FIG. 24 is a diagram illustrating an example of configuring subframes as flexible subframes according to the present invention.

FIG. 25 is a diagram illustrating an example of configuring subframes as flexible subframes according to the present invention.

FIG. 26 is a diagram illustrating an example of multiple bitmaps transmitted to the mobile station devices by the base station device according to the present invention.

FIG. 27 is a diagram illustrating an example of configuring subframes as flexible subframes according to the present invention.

FIG. 28 is a diagram illustrating an example of an information element that can be used for explicit indication of an eCSS ePDCCH-PRBset.

### DESCRIPTION OF EMBODIMENTS

Hereinafter, an embodiment of the present invention will be described in detail with reference to the drawings. First, physical channels according to the present invention will be described.

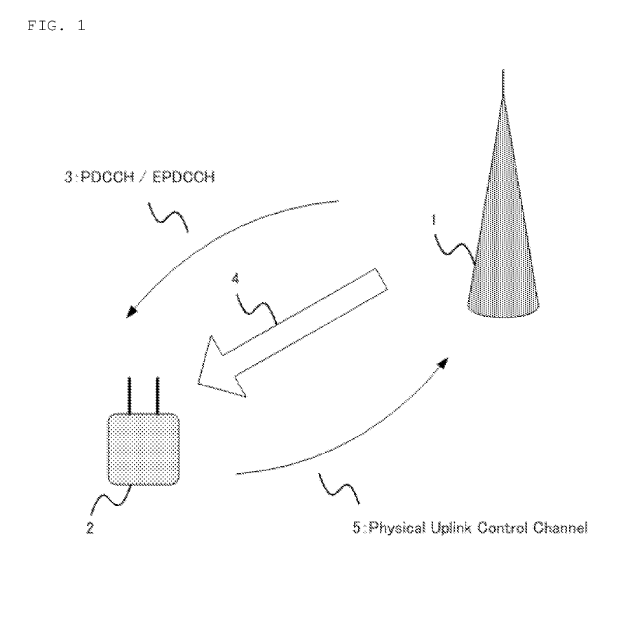

FIG. 1 shows an illustrative communications system. The base station device 1 transmits control information to the mobile station device 2 through Physical Downlink Control Channel (PDCCH) or Enhanced PDCCH (ePDCCH) 3. This control information governs the downlink transmission of data 4. The mobile station device 2 transmits the acknowledgement or negative acknowledgement (ACK/NACK) of reception of the data 4 to the base station device 1 through the Physical Uplink Control Channel (PUCCH) 5.

The information message transmitted in the PDCCH and in the ePDCCH is scrambled with one of many RNTI (Radio Network Temporary Identifier). The used scrambling code helps to differentiate the function of the message, for example, there is an RNTI for paging (P-RNTI), random access (RA-RNTI), cell related operations such as scheduling (C-RNTI), semi-persistent scheduling (SPS-RNTI), system information (SI-RNTI), or messages directed to a group of mobile station devices (UT-group RNTI).

The base station device 1 and the mobile station device 2 communicate with each other according to a series of pre-defined parameters and assumptions corresponding to a selected transmission mode (TM). Transmission modes 1 to 10 have been defined to present a plurality of options covering different scenarios and use cases. For example, TM 1 corresponds to single antenna transmission, TM 2 to transmit diversity, TM 3 to open-loop spatial multiplexing, TM 4 to closed-loop spatial multiplexing, TM 5 to multi-user MIMO (Multiple Input Multiple Output), TM 6 to single layer codebook-based precoding, TM 7 to single-layer transmission using DM-RS, TM 8 to dual-layer transmission using DM-RS, TM 9 to multi-layer transmission using DM-RS, and TM 10 to eight layer transmission using DM-RS.

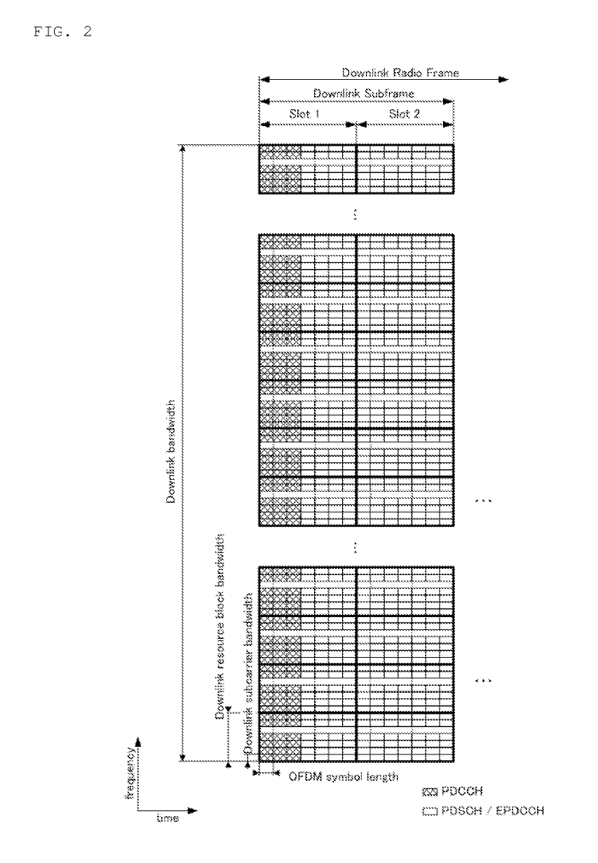

FIG. 2 illustrates a construction example of a downlink subframe. The downlink transmission is performed through OFDMA. A downlink subframe has a length of 1 ms, and can be broadly thought as divided into PDCCH, ePDCCH and PDSCH. Each subframe is composed of two slots. Each slot has a length of 0.5 ms. A slot is further divided into a plurality of OFDM symbols in the time domain, each one of them being composed of a plurality of subcarriers in the frequency domain. In an LTE system one RB includes twelve subcarriers and seven (or six) OFDM symbols. Each subcarrier of each OFDM symbol is a Resource Element (RE). The grouping of all the REs present in a slot composes a Resource Block (RB). The grouping of the two physically consecutive resource blocks present in a subframe composes a Physical Resource Block pair (PRB pair). A PRB pair comprises 12 subcarriers×14 OFDM symbols. The PDCCH region occupies the REs of the first 1 to 4 OFDM symbols of the frame.

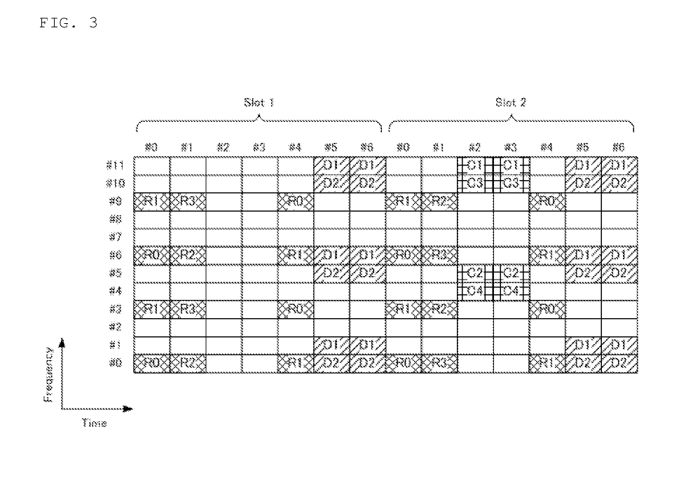

FIG. 3 illustrates an example PRB. Some of the REs of the PRB are occupied by reference signals. The different reference signals are associated to different antenna ports. The term “antenna port” is used to convey the meaning of signal transmission under identical channel conditions. For example, signals sent in the antenna port 0 suffer the same channel conditions, which may differ from those of antenna port 1.

R0-R3 correspond to Cell-specific RS (CRS), which are sent in the same antenna ports as the PDCCH (antenna ports 0-3) and are used to demodulate the data transmitted in the PDCCH, and also to demodulate the data transmitted in the PDSCH in some transmission modes (TM).

D1-D2 correspond to DM-RS associated with ePDCCH. They are sent in the antenna ports 107-110 and serve as demodulation reference signal for the mobile station device to demodulate the ePDCCH therein. The UE-specific reference signals are transmitted in the same REs when configured (not at the same time). The UE-specific reference signals are transmitted in ports 7-14 and serve as demodulation reference signal for the mobile station device to demodulate the PDSCH therein.

C1-C4 correspond to CSI-RS (Channel State Information RS). They are sent in the antenna ports 15-22 and enable the mobile station device to measure the channel conditions.

In the document this configuration is indistinctly referred to as legacy subframe, or subframe configured with CRS.

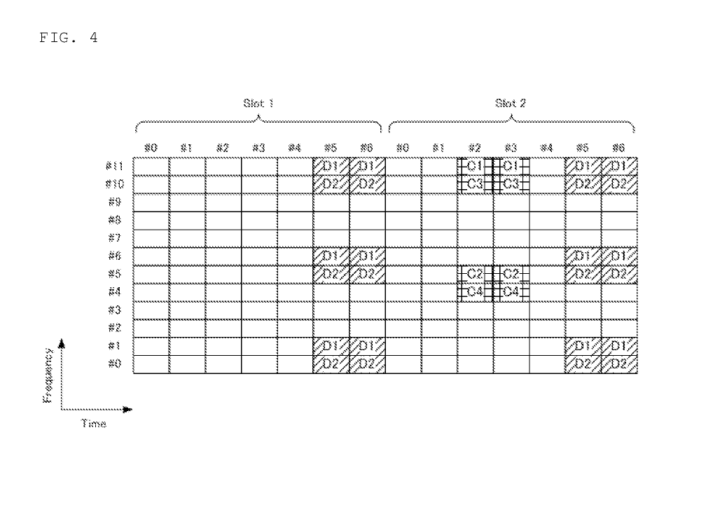

FIG. 4 illustrates an example of a PRB without CRS. This configuration is not supported by legacy terminals. The absence of CRS allows for more REs to be used for data transmission. In the document this configuration is indistinctly referred to as non-legacy subframe, flexible subframe, subframe configured with no CRS, or subframe configured with reduced CRS.

For a given serving cell, if the mobile station device is configured to received PDSCH data transmissions according to transmission modes 1-9, if the mobile station device is configured with a higher layer parameter epdcch-StartSymbol-r11 the starting OFDM symbol l_{EPDCCHstart} for EPDCCH is determined by this parameter. Otherwise the starting OFDM symbol for EPDCCH l_{EPDCCHstart} is given by the CFI (Control Format Indicator) present in the PCFICH (Physical Control Format Indicator Channel) present in the PDSCH region when there are more than ten resource blocks present in the bandwidth, and l_{EPDCCHstart} is given by the CFI value+1 in the subframe of the given serving cell when there are ten or fewer resource blocks present in the bandwidth.

For a given serving cell, if the UE is configured via higher layer signalling to receive PDSCH data transmissions according to transmission mode 10, for each EPDCCH-PRB-set, the starting OFDM symbol for monitoring EPDCCH in subframe k is determined from the higher layer parameter pdsch-Start-r11 as follows:
If the value of the parameter pdsch-Start-r11 is 1, 2, 3 or 4 l′_{EPDCCHstart} is given by that parameter.
Otherwise, l′_{EPDCCHstart} is given by the OFT value in subframe k of the given serving cell when there are more than ten resource blocks present in the bandwidth, and l′_{EPDCCHstart} is given by the CFI value+1 in subframe k of the given serving cell when there are ten or fewer resource blocks present in the bandwidth.
If subframe k is indicated by the higher layer parameter mbsfn-SubframeConfigList-r11 or if subframe k is subframe 1 or 6 for TDD operation l_{EPDCCHstart}=min (2, l′_{EPDCCHstart})
Otherwise l_{EPDCCHstart}=l′_{EPDCCHstart}.

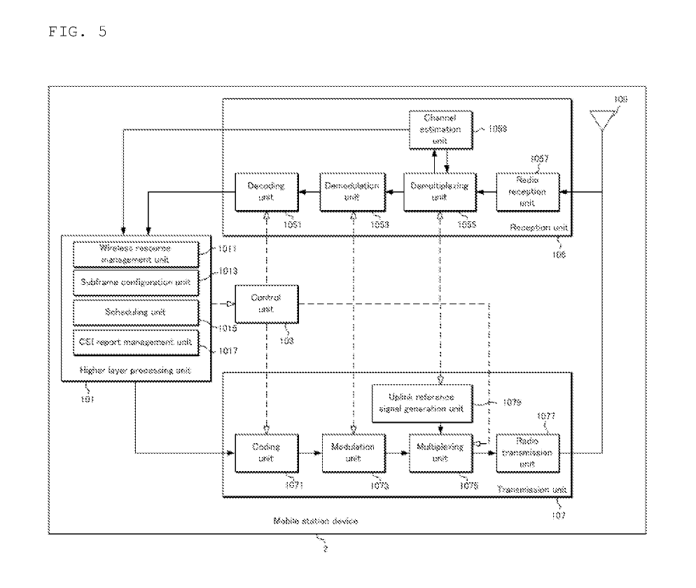

FIG. 5 illustrates the block diagram of a mobile station device that corresponds with the mobile station device 2. As shown in the figure, the mobile station device includes a higher layer processing unit 101, a control unit 103, a reception unit 105, a transmission unit 107, and an antenna unit 109. The higher layer processing unit 101 includes a wireless resource management unit 1011, a subframe configuration unit 1013, a scheduling unit 1015, and a CSI report management unit 1017. The reception unit 105 includes a decoding unit 1051, a demodulation unit 1053, a demultiplexing unit 1055, a radio reception unit 1057, and a channel estimation unit 1059. The transmission unit 107 includes a coding unit 1071, a modulation unit 1073, a multiplexing unit 1075, a radio transmission unit 1077, and an uplink reference signal creation generation 1079.

The higher layer processing unit 101 generates control signal to control the operation of the reception unit 105 and the transmission unit 107 and outputs them to control unit 103. In addition, the upper layer processing unit 101 processes the operations related to the MAC layer (Medium Access Control), the PDCP layer (Packet Data Convergence Protocol), the RLC layer (Radio Link Control), and the RRC layer (Radio Resource Control).

The wireless resource management unit 1011 in the higher layer processing unit 101 manages the configuration related to its own operation. In addition, the wireless resource management unit generates the data that is transmitted in each channel and outputs this information to the transmission unit 107.

The subframe configuration unit 1013 in the higher layer processing unit 101 manages the uplink reference signal configuration, the downlink reference signal configuration, and the transmission direction configuration. The subframe configuration unit 1013 configures subframe sets of at least two subframes.

The scheduling unit 1015 in the higher layer processing unit 101 reads the scheduling information contained in the DCI messages received via the reception unit 105 and outputs control information to control unit 103, which in turn sends control information to reception unit 105 and transmission unit 107 to perform the required operations.

In addition, the scheduling unit 1015 decides the transmission processing and the reception processing timing based on the uplink reference configuration, the downlink reference configuration and/or the transmission direction configuration.

The CST report management unit 1017 in the higher layer processing unit 101 identifies the CSI reference REs. The CSI report management unit 1017 requests channel estimation unit 1059 to derive the channel's CQI (Channel Quality Information) from the CSI references REs. The CSI report management unit 1017 outputs the CQI to the transmission unit 107. The CSI report management unit 1017 sets the configuration of the channel estimation unit 1059.

Control unit 103 generates control signals addressed to reception unit 105 and transmission unit 107 based on the control information received from higher layer processing unit 101. Control unit 103 controls the operation of reception unit 105 and transmission unit 107 through the generated control signals.

Reception unit 105, according to the control information received from control unit 103, receives information from the base station device 1 via the antenna unit 109 and performs demultiplexing, demodulation and decoding to it. Reception unit 105 outputs the result of these operations to higher layer processing unit 101.

The radio reception unit 1057 down-converts the downlink information received from the base station device 1 via the antenna unit 109, eliminates the unnecessary frequency components, performs amplification to bring the signal to an adequate level, and based on the in-phase and quadrature components of the received signal transforms the received analog signal into a digital signal. The radio reception unit 1057 trims the guard interval (GI) from the digital signal and performs FFT (Fast Fourier Transform) to extract the frequency domain signal.

The demultiplexing unit 1055 demultiplexes the PHICH, the PDCCH, the ePDCCH, the PDSCH, and the downlink reference signals from the extracted frequency domain signal. In addition, the demultiplexing unit 1055 performs channel compensation to the PHICH, PDCCH, ePDCCH, and PDSCH, based on the channel estimation values received from the channel estimation unit 1059. The demultiplexing unit 1055 outputs the demultiplexed downlink reference signals to the channel estimation unit 1059.

The demodulation unit 1053 performs multiplication by the code corresponding to the PHICH, performs BPSK (Binary Phase Shift Keying) demodulation to the resulting signal, and outputs the result to the decoding unit 1051. The decoding unit 1051 decodes the PHICH addressed to the mobile station device 2 and transmits the decoded HARQ indicator to the higher layer processing unit 101. The demodulation unit 1053 performs QPSK (Quadrature Phase Shift Keying) demodulation to the PDCCH and/or ePDCCH and outputs the result to the decoding unit 1051. The decoding unit 1051 attempts to decode the PDCCH and/or the ePDCCH. If the decoding operation is successful, the decoding unit 1051 transmits the downlink control information and the corresponding RNTI to the higher layer processing unit 101.

The demodulation unit 1053 demodulates the PDSCH addressed to mobile station device 2 as indicated by the downlink control grant indication (QPSK, 16QAM (Quadrature Amplitude Modulation), 64QAM, or other), and outputs the result to the decoding unit 1051. The decoding unit 1051 performs decoding as indicated by the downlink control grant indication and outputs the decoded downlink data (transport block) to the higher layer processing unit 101.

The channel estimation unit 1059 estimates the pathloss and the channel conditions from the downlink reference signals received from the demultiplexing unit 1055 and outputs the estimated pathloss and channel conditions to the higher layer processing unit 101. In addition, the channel estimation unit 1059 outputs the channel values estimated from the downlink reference signals to the demultiplexing unit 1055. In order to compute the CQI, the channel estimation unit 1059 performs measurements to the channel and/or interference.

The transmission unit 107, according to the control information received from control unit 103, generates the uplink reference signals, performs coding and modulation to the uplink data received from the higher layer processing unit (transport block), multiplexes the PUSCH, the PUSCH and the generated uplink reference signals, and transmits it to the base station 1 through the antenna unit 109.

The coding unit 1071 performs block coding, convolutional coding, or others, to the uplink control information received from the higher layer processing unit 101. In addition, the coding unit 1071 performs turbo coding to the scheduled PUSCH data.

The modulation unit 1073 performs modulation (BPSK, QPSK, 16QAM, 64QAM, or other) to the coded bitstream received from coding unit 1071 according to the downlink control indication received from base station device 1 or to a pre-defined modulation convention for each channel. Modulation unit 1073 decides the number of PUSCH streams to transmit through spatial multiplexing, maps the uplink data to that number of different streams, and performs MIMO SM (Multiple Input Multiple Output Spatial Multiplexing) precoding to those streams.

Uplink reference signal generation unit 1079 generates a bit stream following a series of pre-defined rules in accordance to the PCI (Physical Cell Identity, or Cell ID) for the base station device 1 to be able to discern the signals sent from the mobile station device 2, the value of the bandwidth in which to place the uplink reference signals, the cyclic shift indicated in the uplink grant, and the value of the parameters related to the DMRS sequence generation. The multiplexing unit 1075 arranges the PUSCH modulated symbols in different streams and performs OFT (Discrete Fourier Transform) to them according to the indications given by control unit 103. In addition, the multiplexing unit 1075 multiplexes the PUCCH, the PUSCH, and the generated reference signals in their corresponding REs in their appropriate antenna ports.

Radio transmission unit 1077 performs IFFT (Inverse Fast Fourier Transform) to the multiplexed signals, performs SC-FDMA modulation (Single Carrier Frequency Division Multiple Access) to them, adds the GI to the resulting streams, generates the digital baseband signal, transforms the digital baseband signal into an analog baseband signal, generates the in-phase and quadrature components of the analog signal and up-converts it, removes the unnecessary frequency components, performs power amplification, and outputs the resulting signal to antenna unit 109.

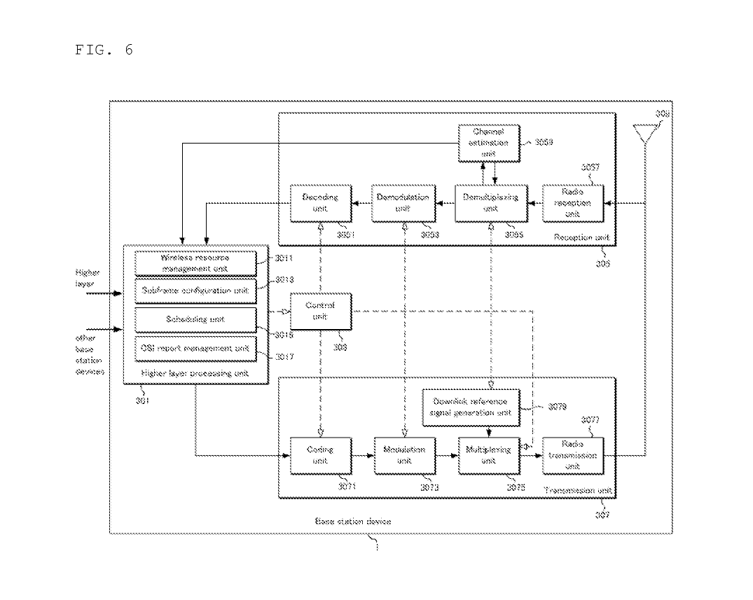

FIG. 6 illustrates the block diagram of a base station device that corresponds with the base station device 1. As shown in the figure, the mobile station device includes a higher layer processing unit 301, a control unit 303, a reception unit 305, a transmission unit 307, and an antenna unit 309. The higher layer processing unit 301 includes a wireless resource management unit 3011, a subframe configuration unit 3013, a scheduling unit 3015, and a CSI report management unit 3017. The reception unit 305 includes a decoding unit 3051, a demodulation unit 3053, a demultiplexing unit 3055, a radio reception unit 3057, and a channel estimation unit 3059. The transmission unit 307 includes a coding unit 3071, a modulation unit 3073, a multiplexing unit 3075, a radio transmission unit 3077, and a downlink reference signal creation generation 3079.

The higher layer processing unit 301 generates control signal to control the operation of the reception unit 305 and the transmission unit 307 and outputs them to control unit 303. In addition, the upper layer processing unit 301 processes the operations related to the MAC layer (Medium Access Control), the PDCP layer (Packet Data Convergence Protocol), the RLC layer (Radio Link Control), and the RRC layer (Radio Resource Control).

The wireless resource management unit 3011 in the higher layer processing unit 301 generates the downlink data to transmit in the downlink PDSCH (transport block), the system information, the RRC messages, and the MAC CE (Control Element) and outputs it to the transmission unit 307. Alternatively, this information can be obtained from a higher layer. In addition, the wireless resource management unit 3011 manages the configuration information of each mobile station device.

The subframe configuration unit 3013 in the higher layer processing unit 301 manages the uplink reference signal configuration, the downlink reference signal configuration, and the transmission direction configuration of each mobile station device.

The subframe configuration unit 3013 generates a first parameter “uplink reference signal configuration”, a second parameter “downlink reference signal configuration”, and a third parameter “transmission direction configuration”. The subframe configuration unit 3013 transmits the three parameters to the mobile station device 2 via the transmission unit 307.

The base station device 1 may decide the uplink reference signal configuration, the downlink reference signal configuration, and/or the transmission direction configuration. Alternatively, either of these parameters may be configured by a higher layer.

For example, the subframe configuration unit 3013 may decide the uplink reference signal configuration, the downlink reference signal configuration, and/or the transmission direction configuration based on the traffic conditions of the uplink or the downlink.

The subframe configuration unit 3013 manages sets of at least two subframes. The subframe configuration unit 3013 may manage a set of at least 2 subframes for each mobile station device. The subframe configuration unit 3013 may manage a set of at least two subframes for each serving cell. The subframe configuration unit 3013 may manage a set of at least two subframes for each CSI process.

The subframe configuration unit 3013 transmits the configuration information corresponding to a set of at least two subframes to the mobile station device 2 through the transmission unit 307.

The scheduling unit 3015 in the higher layer processing unit 301 decides the frequency and subframe allocation of the physical channels (PDSCH and PUSCH), and their appropriate coding rate, modulation and transmission power according to the channel condition report received from the mobile station 2 and the channel estimation and channel quality parameters received from channel estimation unit 3059. The scheduling unit 3015 decides if the flexible subframes are used for downlink physical channel and/or downlink physical signal scheduling or for uplink physical channel and/or uplink physical signal scheduling. The scheduling unit 3015 generates control signals (for example, with the DCI format (Downlink Control Information)) to control the reception unit 305 and the transmission unit 307 based on the resulting scheduling and outputs them to the control unit 303.

The scheduling unit 3015 generates the report that carries the scheduling information for the physical channels (PUSCH and PUSCH) based on the resulting scheduling. Furthermore, the scheduling unit 3015 decides the reception and transmission timing based on the uplink reference signal configuration, the downlink reference signal configuration, and/or the transmission direction configuration.

The CST report management unit 3017 in the higher layer processing 301 controls the CSI report of the mobile station device 1. The CSI report management unit 3017 transmits to the mobile station device 2 the configuration information for deriving the CQI from the CSI reference signal REs via the antenna unit 309.

The control unit 303 generates the control signals to manage the reception unit 305 and the transmission unit 307 according to the control signals received from the higher layer processing unit 301. The control unit 303 outputs these signals to the reception unit 305 and the transmission unit 307 and controls their operation.

Reception unit 305, according to the control information received from control unit 303, receives information from the mobile station device 2 via the antenna unit 309 and performs demultiplexing, demodulation and decoding to it. Reception unit 305 outputs the result of these operations to higher layer processing unit 3101.

The radio reception unit 3057 down-converts the downlink information received from the mobile station device 2 via the antenna unit 309, eliminates the unnecessary frequency components, performs amplification to bring the signal to an adequate level, and based on the in-phase and quadrature components of the received signal transforms the received analog signal into a digital signal. The radio reception unit 3057 trims the guard interval (GI) from the digital signal and performs FFT (Fast Fourier Transform) to extract the frequency domain signal.

The demultiplexing unit 3055 demultiplexes the PUCCI-7, the PUSCH and the reference signals of the received signal from the radio reception unit 3057. This demultiplexing is performed according to the uplink grant and the wireless resource allocation information sent to the mobile station 2. In addition, the demultiplexing unit 3055 performs channel compensation of the PUCCH and the PUSCH according to the channel estimation values received from the channel estimation unit 3059. In addition, the demultiplexing unit 3055 gives the demultiplexed uplink reference signal to the channel estimation unit 3059.

The demodulation unit 3053 performs IDFT (Inverse Discrete Fourier Transform) to the PUSCH, obtains the modulated symbols, and performs demodulation (BPSK, QPSK, 16QAM, 64QAM, or other) for each PUCCH and PUSCH symbol according to the modulation configuration transmitted to the mobile station 2 in the uplink grant notification or according to another pre-defined configuration. The demodulation unit 3053 separates the symbols received in the PUSCH according to the MIMO SM precoding configuration transmitted to the mobile station 2 in the uplink grant notification or according to another pre-defined configuration.

The decoding unit 3051 decodes the received uplink data in the PUSCCH and the PUSCH according to the coding rate configuration transmitted to the mobile station 2 in the uplink grant notification or according to another pre-defined configuration, and outputs the resulting stream to the higher layer processing unit 301. In the case of retransmitted PUSCH the decoding unit 3051 decodes the received demodulated bits using the coded bits that are held in the HARQ buffer in the higher processing unit 301. The channel estimation unit 3059 estimates the channel conditions and the channel quality using the uplink reference signal received from the demultiplexing unit 3055, and outputs this information to the demultiplexing unit 3055 and the higher layer process unit 301.

The transmission unit 307, according to the control information received from control unit 303, generates the downlink reference signal, prepares the downlink control information including the HARQ indicator received from the higher layer processing unit 301, performs coding and modulation of the downlink data, multiplexes the result with the PHICH, the PDCCH, the ePDCCH, the PDSCH and the downlink reference signal, and transmit the resulting signal to the mobile station device 2 via the antenna unit 309.

The coding unit 3071 performs block coding, convolutional coding, turbo coding, or other, to the HARQ indicator received from the higher layer processing 301, the downlink control information and the downlink data, according to the coding configuration decided by the wireless resource management unit 3011 or according to another pre-defined configuration. The modulation unit 3073 performs modulation (BPSK, QPSK, 16QAM, 64QAM, or other) to the coded bitstream received from coding unit 3071 according to the modulation configuration decided by the wireless resource management unit 3011 or according to another pre-defined configuration.

The downlink reference signal generation unit 3079 generates downlink reference signals well known by the mobile station device 2 according to some pre-defined rules and employing the PCT (Physical Cell Identity) value, which allows the mobile station device 2 to discern the transmission of the base station device 1. The multiplexing unit 3075 multiplexes the modulated symbols in each channel and the generated downlink reference signals in their corresponding REs in their appropriate antenna port.

The radio transmission unit 3077 performs IFFT (Inverse Fast Fourier Transform) to the multiplexed symbols, OFDM modulation, adds the guard interval to the OFDM symbols, generates the digital baseband signal, transforms the digital baseband signal into an analog baseband signal, generates the in-phase and quadrature components of the analog signal and up-converts it, removes the unnecessary frequency components, performs power amplification, and outputs the resulting signal to antenna unit 309.

The number of available resources for transmission of control or information data depends on the reference signals present in each resource block. The base station device is configured to avoid the transmission of data in these REs by a proper resource element mapping.

The mobile station device assumes the resource element mapping that is used at any given time to retrieve the data. The data is mapped in sequence to REs on the associated antenna port which fulfill that they are part of the EREGs assigned for the EPDCCH transmission, they are assumed by the UE not to be used for CRS or for CSI-RS, and they are located in an OFDM symbol that is equal or higher than the starting OFDM symbol indicated by l_{EPDCCHstart}.

In the PDCCH region a CCE is defined to always have 4 available REs to transmit information. In order to do this the CCE configuration presents some variations depending on the number of CRS present or the reach of the PHICH. The result is that the PDCCH messages always have the same number of bits.

However, in the ePDCCH/PDSCH region the number of bits is variable. In order to be able to use all the available REs the base station mobile must accommodate the data to them. This is achieved by rate matching.

The rate matching operation generates a stream of bits of the required size by varying the code rate of the turbo code operation. The rate matching algorithm is capable of producing any arbitrary rate. The bitstreams from the turbo encoder undergo an interleave operation followed by bit collection to create a circular buffer. Bits are selected and pruned from the buffer to create a single bitstream with the desired code rate.

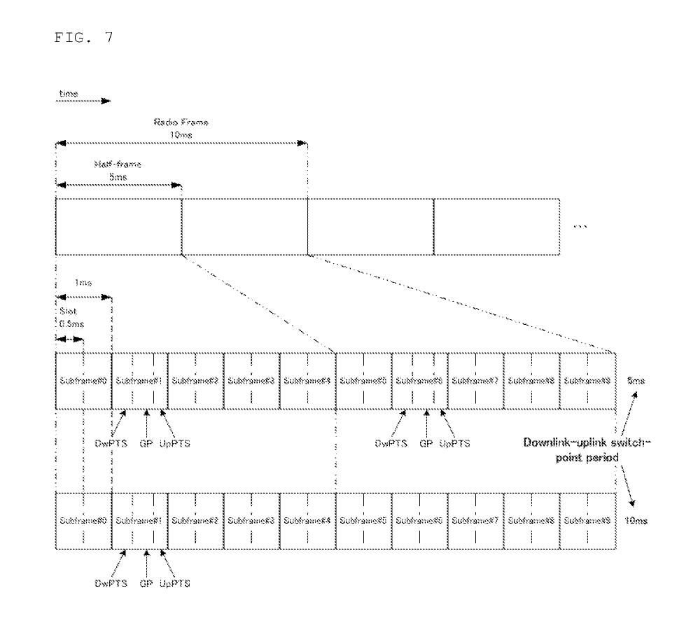

FIG. 7 illustrates the composition of an LTE radio frame in the Time Division Duplex mode (TDD).

An LTE radio frame has a length of 10 ms, and is composed of 10 subframes.

Each subframe can be used for downlink or uplink communication as configured by the eNB. The switch from downlink to uplink transmission is performed through a special subframe that acts as switch-point. Depending on the configuration a radio frame can have 1 special subframe (switch-point periodicity of 10 ms) or 2 special subframes (switch-point periodicity of 5 ms).

In most cases subframes #1 and #7 are the “special subframe”, and include the three fields DwPTS (Downlink Pilot Time Slot), GP (Guard Period) and UpPTS (Uplink Pilot Time Slot). DwPTS spans a plurality of OFDM symbols and is dedicated to downlink transmission. GP spans a plurality of OFDM symbols and is empty. GP is longer or shorter depending on the system conditions to allow for a smooth transition between downlink and uplink. UpPTS spans a plurality of OFDM symbols and is dedicated to uplink transmission. DwPTS carries the Primary Synchronization Signal (PSS). Subframes #0 and #5 carry the Secondary Synchronization Signal (SSS), and therefore cannot be configured for uplink transmission. Subframe #2 is always configured for uplink transmission.

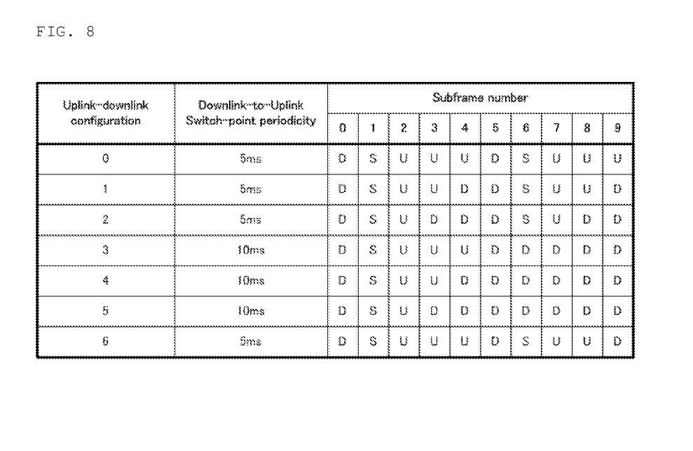

FIG. 8 lists the possible Uplink-Downlink configurations, where “U” denotes that the subframe is reserved for uplink transmission, “D” denotes that the subframe is reserved for downlink transmission, and “S” denotes the special subframe. The base station device transmits the index of the Uplink-Downlink configuration to be used to the mobile station device.

The base station device can transmit a second Uplink-Downlink configuration index. The subframes in which both Uplink-Downlink have the same configuration are handled as described above (they are indistinctly referred to as legacy subframes in the rest of the documents). The subframes in which both Uplink-Downlink configurations differ are flexible subframes, which are subframes that can be used for either uplink or downlink. For example, Uplink-Downlink configuration 1 is configured as U, while Uplink-Downlink configuration 2 is configured as D or S.

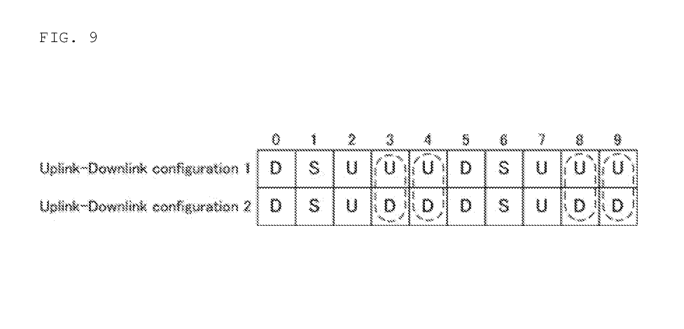

FIG. 9 illustrates an example method in which the base station device can indicate the uplink-downlink configuration that involves flexible subframes.

In this example, the base station device transmits two uplink-downlink configuration indexes. The first one corresponds to the configuration #0, in which there are defined the highest number of uplink subframes. The second configuration is chosen by the base station device to indicate the flexible subframes. The subframes that are configured as uplink in the first configuration and as downlink in the second configuration are the flexible subframes.

In the example, the second index corresponds to the configuration #2, in which four of the subframes that are marked as uplink in the configuration #1 are marked as downlink, and therefore they are flexible subframes (more precisely, subframes #3, #4, #8, and #9).

Legacy mobile station devices consider the flexible subframes to be configured for uplink. Legacy mobile station devices do not expect PDCCH to be sent and do not monitor the USS or the CSS. The base station device does not need to preserve legacy compatibility in these subframes. The base station device can totally eliminate the CRS and start transmitting in the OFDM symbol #0, increasing the data throughput for compatible mobile station devices.

The actual direction of the flexible subframe (uplink or downlink) is given implicitly. A mobile station device that is compatible with flexible subframes assumes that the direction is downlink if no uplink scheduling grant is given to him in that subframe. Otherwise, the mobile station device monitors the ePDCCH of that subframe. If the mobile station device has an uplink scheduling grant in that subframe it assumes no downlink ePDCCH and proceeds with the uplink data transmission.

A flexible subframe that is immediately after another flexible subframe that has been configured for downlink transmission is not configured as uplink. A guard period is necessary for switching from downlink to uplink, and that guard period is only defined in the special subframes.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, and average delay. A mobile station device does not assume that two antenna ports are quasi co-located unless specified otherwise by the base station device.

A mobile station device configured in transmission mode 10 for a serving cell is configured with one of two quasi co-location types for the serving cell by higher layer parameter qcl-Operation to decode the PDSCH or the ePDCCH.
Type A: the mobile station device may assume the antenna ports 0-3 (corresponding to CRS), 7-22 (UE-specific RS and CSI-RS), and 107-110 (corresponding to DM-RS associated with ePDCCH) of a serving cell are quasi co-located with respect to delay spread, Doppler spread, Doppler shift, and average delay.
Type B: the mobile station device may assume the antenna ports 15-22 (corresponding to CSI-RS resource configuration identified by the higher layer parameter gcl-CSI-RS-ConfigNZPId-r11, the antenna ports 7-14 (UE-specific RS), and the antenna ports 107-110 (corresponding to DM-RS associated with ePDCCH) are quasi co-located with respect to delay spread, Doppler spread, Doppler shift, and average delay.

A mobile station configured in transmission mode 10 for a given serving cell can be configured with up to 4 parameter sets by the base station device to decode PDSCH or ePDCCH. The mobile station device uses the parameter set according to the value of the “PDSCH RE Mapping and Quasi-Co-Location Indicator” field (PQI) for determining the PDSCH/ePDCCH RE mapping and for determining the antenna port quasi co-location if the mobile station is configured with Type B quasi co-location type. PQT acts as an index for the 4 configurable parameter sets.

The parameter set referenced by PQI includes crs-PortsCount-r11 (number of antenna ports), crs-FreqShift-r11 (frequency shift of the CRS), mbsfn-SubframeConfigList-r11 (definition of the subframes that are reserved for MBSFN in downlink), csi-RS-ConfigZPId-r11 (identification of a CSI-RS resource configuration for which the mobile station device assumes zero transmission power), pdsch-Start-r11 (starting OFDM symbol) and qct-CSI-RS-ConfigNZPId-r11 (CSI-RS resource that is quasi co-located with the PDSCH/ePDCCH antenna ports).

In a typical network the coverage of multiple base station devices overlaps in some areas. A system may allow for a mobile station device to be served by any of these base station devices in a transparent way, without the need for the mobile station device to perform a handover to a base station device prior to receiving from it. The base station device in the serving cell configures through RRC messages the quasi co-location parameter set that matches the conditions of the overlapping base station devices. The overlapping base station devices can transmit to the mobile station device with no interruption of service if the mobile station device switches to the right PQI parameter set.

The PDOCH region of a PRB pair spans the first 1, 2, 3 or 4 OFDM symbols. The rest of the OFDM symbols are used as the data region (PDCCH, Physical Downlink Shared channel). The PDCCH is sent in the antenna ports 0-3, along with the CRS.

The CRS are allocated to REs across the PRB according to a pattern that is independent of the length of the PDCCH region and the data region. The number of CRS in a PRE depends on the number of antennas that are configured for the transmission.

The Physical Control Format Indicator Channel (PCFICH) is allocated in the first OFDM symbol to REs that are not allocated to CRS. The PCFICH is composed of 4 Resource Element Group (REG), each REG being composed of 4 REs. It contains a value from 1 to 3 (or 2 to 4 depending on the bandwidth), corresponding to the length of the physical downlink control channel (PDCCH).

The Physical Hybrid-ARQ Indicator Channel (PHICH, where ARQ stands for Automatic Repeat-reQuest) is allocated in the first symbol to REs that are not allocated to CRS or PCFICH. It transmits the HARQ ACK/NACK signals for uplink transmission. The PHICH is composed of 1 REG, and is scrambled in a cell-specific manner. A plurality of PHICHs can be multiplexed in the same REs and conform a PHICH group. A PHICH group is repeated 3 times to obtain diversity gain in the frequency and/or time region.

The PDCCH is allocated in the first ‘n’ OFDM symbols (where ‘n’ is indicated by the PCFICH). The PDCCH contains the Downlink Control Information (DCI) messages, which may contain downlink and uplink scheduling information, downlink ACK/NACK, power control information, etc. The DCI is carried by a plurality of Control Channel Elements (CCE). A CCE is composed of 4 consecutive REs in the same OFDM symbol that are not occupied by CRS, the PCFICH, or the PHICH.

The CCEs are numbered starting from 0 in ascending order first of frequency and second of time. First the lowest frequency RE in the first OFDM symbol is considered. If that RE is not occupied by other CCE, CRS, REICH, or PCFICH, it is numbered. Otherwise the same RE corresponding to the next OFDM symbol is evaluated. Once all OFDM symbol's have been considered the process is repeated for all REs in frequency order.

The REs that are not occupied by a reference signal in the data region can be allocated to ePDCCH or Physical Downlink Shared Cannel (PDCCH).

The UE monitors a set of PDCCH candidates, where monitoring implies attempting to decode each of the PDCCHs in the set according to all monitored DCI formats. The set of PDCCH candidates to monitor are defined in terms of Search Spaces (SS), where a search space Sₖ^{(L)} at a given aggregation level L is defined by a set of PDCCH candidates.

Each UE monitors two search spaces, the UE-specific Search Space (USS) and the Common Search Space (CSS). The USS carries information that is directed exclusively to the UE, therefore only the pertinent UE-can decode it. The USS is different for each UE. USS of two or more mobile station devices can be partially overlapped. The CSS contains general information that is directed to all UEs. All UEs monitor the same common search space and are able to decode the information therein.

A search space can be defined implicitly depending on some parameter such as the cell ID, the RNTI associated with the type of message and/or the mobile station device or a group thereof, the slot number within a radio frame, and/or the bandwidth. For example, a mathematical operation can be defined based on the cell ID and the mobile station ID according to which the USS ECCEs that are considered for each aggregation level are known by the base station device and the mobile station device. The CSS can be obtained using the same equation or a similar one in which the mobile station ID is not taken into account (for example, overriding it with the value zero).

Alternatively, the USS and/or the CSS can be fixed. The search space defined for each aggregation level is well known, and all the mobile station devices monitor them.

Alternatively, the USS and/or the CSS can be explicitly indicated by the base station device. Each mobile station device receives this information through MIB, SIB, RRC, or a combination thereof.

The common search space is the same for all mobile station devices or for a group thereof (UE-grouped). A group of mobile station devices can be defined as UE-grouped, for example, by setting a specific RNTI to them (US-group RNTI). The mobile station devices belonging to a group monitor the CSS and/or the eCSS looking for messages sent with this RNTI.

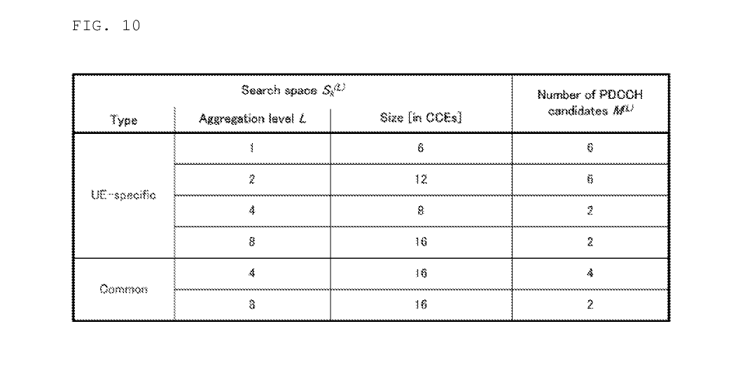

FIG. 10 contains the values that a mobile station device monitors for each aggregation level in the USS and the CSS. The aggregation level is the number of CCEs that a PDCCH uses. The mobile station device monitors a number of PDCCH candidates M^{(L)} for each aggregation level. For the common search space L can take one of two values, L=4 or L=8. The number of candidates the UE monitors is M^{(L)}=4 for L=4 and M^{(L)}=2 for L=8. The size of the search space of each of the cases is 16 CCEs.

The basic unit of the Enhanced PDCCH (ePDCCH) is the Enhanced Resource Element Group (EREG). The REs of a PRB pair are cyclically numbered from 0 to 15 in ascending order of frequency and OFDM symbol skipping the REs that may contain DMRS (DeModulation Reference Signals). The same transmission processing that is applied to the PDSCH is applied to the DMRS, which allows the UE to obtain the information it needs to be able to demodulate the data. EREGᵢ is composed of all the REs with number ‘i’, where i=0, 1, . . . 15.

However, the number of REs that can be used is not fixed. The REs used for PDCCH, CRS and CSI-RS (Channel State Information Reference Signal) cannot be used for ePDCCH. The CSI-RS are transmitted periodically to enable the UT to measure the channel conditions of up to 8 antennas, and it is not defined for special subframe configurations.

The control information is transmitted in Enhanced CCEs (ECCEs), which are composed of 4 or 8 EREGs, depending on the number of REs that are available for transmission in each ECCE for a given configuration.

There can be 1 or 2 sets of ePDCCH-sets simultaneously, each one independently configurable and spanning 1, 2, 4 or 8 FRB pairs. The ePDCCH is sent in the antenna ports 107-110, along with the DM-RS.

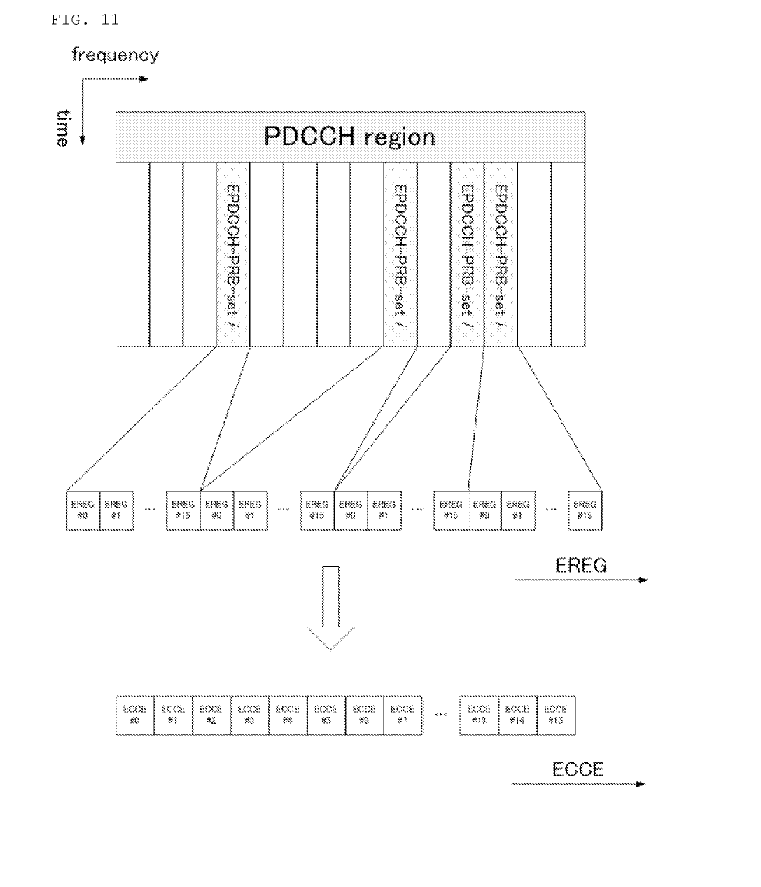

FIG. 11 illustrates the mapping of the ECCEs of the ePDCCH in the PRB-pairs of ePDCCH-set i (where i=0, 1, 2, etc.). Each PRB-pair is composed of 16 EREGs. The EREGs of all the PRB-pairs together can be considered as the EREGs of the ePDCCH-set. A PRB pair comprises 16 EREGs, which can compose 4 or 2 ECCEs. In the example of the figure one ECCE is assumed to be composed of 4 EREGs.

In a localized allocation, each ECCE of the ePDCCH is composed of EREGs belonging to a single a PRB pair. Due to all the REGs being in a relatively narrow band, higher benefits can be obtained through precoding and scheduling.

In a distributed allocation, each EDGE of the ePDCCH is composed of EREGs belonging to different ERB pairs. Due to the frequency hopping performed to the REGs, the robustness is increased through frequency diversity.

In consideration to localized or distributed allocation of the control information, ePDCCH set 0 does not condition ePDCCH set 1 (if present). ePDCCH set 0 and ePDCCH set 1 are defined for any combination of localized and/or distributed transmission mapping.

UE-specific search space is defined for ePDCCH as ePDCCH USS (also referred to as eUSS). The search space of each ePDCCH-PRB-set is independently configured.

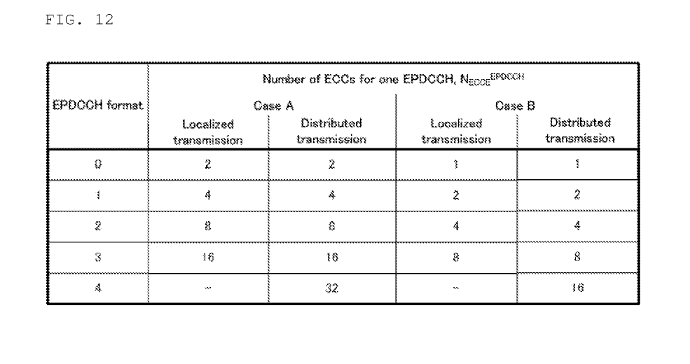

FIG. 12 contains the number of ECCEs that constitute an ePDCCH for each ePDCCH format. Case A applies for normal subframes and normal downlink CP when DCI formats 2/2A/2B/2C/2D are monitored and the number of available downlink resource blocks of the serving cell is 25 or more; or for special subframes with special subframe configuration 3, 4, 8 and normal downlink CP when DCI formats 2/2A/2B/2C/2D are monitored and the number of available downlink resource blocks of the serving cell is 25 or more; or for normal subframes and normal downlink CP when DCI formats 1A/1B/1D/1/2/2A/2B/2C/2D/0/4 are monitored, and when n_{EPDCCH}<104; or for special subframes with special subframe configuration 3, 4, 8 and normal downlink CP when DCI formats 1A/1B/1D/1/2A/2/2B/2C/2D/0/4 are monitored, and when n_{EPDCCH}<104. Otherwise, case B is used.

The quantity n_{EPDCCH} (the number of REG available in an ECCE) for a particular mobile station device and referenced above is defined as the number of downlink REs in a PRB-pair configured for possible EPDCCH transmission of a EPDCCH-set fulfilling that they are part of any one of the 16 EREGs in the PRB-pair, they are assumed by the UE not to be used for CRS or for CSI-RS, and they are located in an OFDM symbol l equal or higher than the starting OFDM symbol (l≧l_{EPPCCHstart}).

The quantity n_{EPDCCH,CSS} (the number of REG available in an ECCE of a FRB dedicated to common signaling) for a particular mobile station device and referenced above is defined as the number of downlink REs in a PRB-pair configured for possible EPDCCH transmission of a EPDCCH-set defined for common signaling fulfilling that they are part of any one of the 16 EREGs in the PRS-pair, they are assumed by the HE not to be used for CRS or for CSI-RS, and they are located in an OFDM symbol l equal or higher than the starting OFDM symbol (l≧l_{EPDCCHstart}). In one example, n_{EPDCCH,CSS} may be assumed to be fixed. In another example n_{EPDCCH,CSS} has a value that depends on many other parameters, for instance the starting symbol for EPDCCH l_{EPDCCHstart}. l_{EPDCCHStart} or related parameters could be given by RRC signaling, PDCCH, EPDCCH, etc.

The format of the DCI depends on the purpose the ePDCCH is transmitted for. Format 0 is usually transmitted for uplink scheduling and uplink power control. Format 1 is usually transmitted for downlink SIMO (Single Input Multiple Output) scheduling and uplink power control. Format 2 is usually transmitted for downlink MIMO scheduling and uplink power control. Format 3 is usually transmitted for uplink power control. Format 4 is usually transmitted for uplink scheduling of up to four layers.

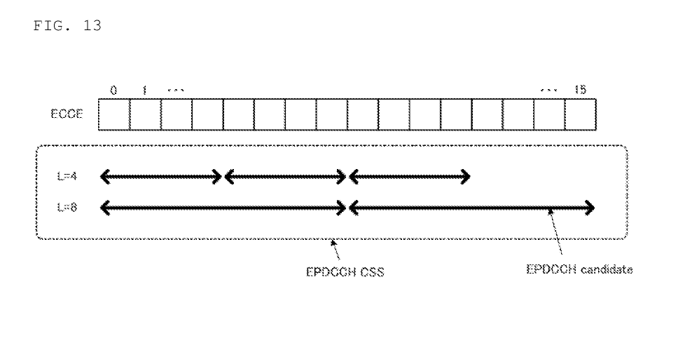

FIG. 13 illustrates an example common search space for EPDCCH. The candidate ePDCCHs are represented over the ECCEs, therefore the example is valid for both localized and distributed transmission.

In this example there are three candidates defined with aggregation level 4 and two candidates with aggregation level 8, but the invention is not constrained to these values, other quantities are also included, as well as other aggregation levels.

The candidate ePDCCHs could be fixed, always present in the same ECCEs, or their position could be dependent on other parameters, such as the cell identity, the bandwidth, etc. According to one or more of these parameters the starting position of the first candidate could be moved to any ECCE that are part of the search space.

Additionally, a separation could be present between candidate ePDCCHs when possible. In the example the two candidates with aggregation level 8 fit snuggly in the search space, and no separation can be defined between them. The starting position of the first candidate could be either ECCE #0 or ECCE #8, in which case the second candidate would start in the ECCE #0. For the aggregation level 4 there are more possibilities for both starting position and separation between candidates.

An embodiment of this invention introduces the enhanced common search space (ECSS) for ePDCCH in a separate ePDCCH-set, for example ePDCCH-set 2.

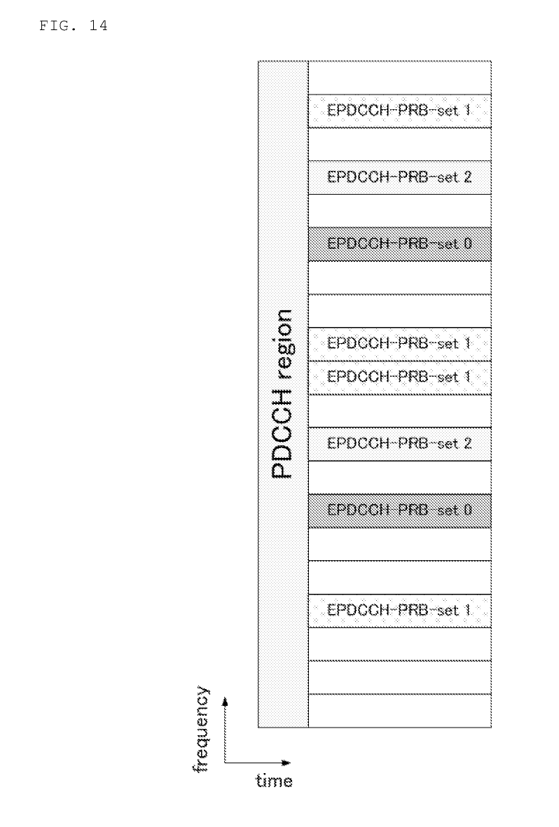

FIG. 14 illustrates an example in which ePDCCH-set 2 is introduced. In this example ePDCCH-set 0 and 1 correspond to the eUSS. ePDCCH-set 2 is the ePDCCH-set associated with the eCSS. In the rest of the document the ePDCCH-set associated with the eCSS may be referred to as ePDCCH-set 2 without loss of generality.

The allocation of the ECCEs in the FRB-pairs can be done in a process akin to distributed mapping. The common control channel information is intended to reach mobile station devices that are in occasions far from the base station device or under low coverage conditions. Distributed mapping helps to increase the robustness of the ECSS through frequency diversity. However, as will be pointed in the following, localized mapping is advantageous in some occasions, and therefore its use is not precluded in this invention.

EPDCCH-PRB-set 2 can have different PRB spans in direct correlation with the aggregation level that is needed or expected for the common control channel information.

In an embodiment of the invention the number and/or position of the PRBs composing ePDCCH-set 2 is fixed and known by both the base station devices and the mobile station devices. The base station device transmits its common control channel information in these known PRBs, and the mobile station devices are expected to monitor them. The base station device may transmit the common control channel information in part of the available ECCEs, and leave the rest empty.

Alternatively, the base station device may decide how many of the pre-defined PRBs to use for common control channel information, leaving the rest available for data transmission.

In the case of distributed mapping of the ECCEs the mobile station devices monitor all candidate PRBs in the ECSS and attempt to decode a common control channel in all the possible configurations. For example, an instance of ECSS is fixed and defined in four PRBs, but the base station device only needs to transmit in two of those PRBs, the other two PRBs being used for data. The mobile station devices are not aware of this usage, and therefore attempt to decode the ECSS corresponding to four PRBs and the ECSS corresponding to two PRBs.

In another embodiment of the invention the mapping of the ECCS to the PRBs corresponds to the localized mapping method. The base station device starts allocating the common control information to the PRBs in a pre-defined order. For example, the order can correspond to the ascending values of frequency, in which the base station device allocates the common control information to the PRB with the lowest frequency among the PRBs that have not been allocated yet. Another example is to order the PRBs with relation to their proximity to the DC carrier (center of the bandwidth in frequency), choosing a PRB according to some criterion in case two PRBs are equidistant to the DC carrier (for example, the lowest frequency PRB is allocated first). In this case the mobile station devices monitor the PRBs in sequential order until a PRB with unused ECCEs is detected, skipping the blind decoding of the remaining PRBs. Alternatively, the mobile station devices may monitor all the PRBs.

In another embodiment of the invention the number and/or position of the PRBs composing ePDCCH-set 2 is implicit, according to some other parameter of the system, for example the bandwidth or the cell ID (cell identity). For example, the mobile station device performs initial access to a network and receives the bandwidth information from the base station device, which corresponds to a pre-defined ePDCCH configuration. In another example, the mobile station device acquires the cell ID from the mobile station device in the initial access procedure and performs a mathematical operation to obtain the size and the location of the ePDCCH-PRB-set 2. These and other similar methods are not exclusive, in another example the size of the ePDCCH-PRB-set may depend on the bandwidth of the network, while the location of the ePDCCH-PRB-set PRBs may depend on the cell ID.

In another embodiment of the invention the configuration of the ePDCCH-set 2 is explicitly given by the base station device.

In another embodiment of the invention either the size or the location of the ePDCCH-set is fixed/implicit, or explicit, while the other parameter, independently, is fixed, implicit, or explicit.

Additionally, the eCSS can be also fixed, implicit or explicit. The number of monitoring candidates for each aggregation level may be fixed, implicit (for example dependent on the bandwidth), or given explicitly by the base station device. The starting position of each of these monitoring candidates can be independently fixed, implicit (for example dependent on the RNTI, or the slot number within a radio frame), or given explicitly by the base station device.

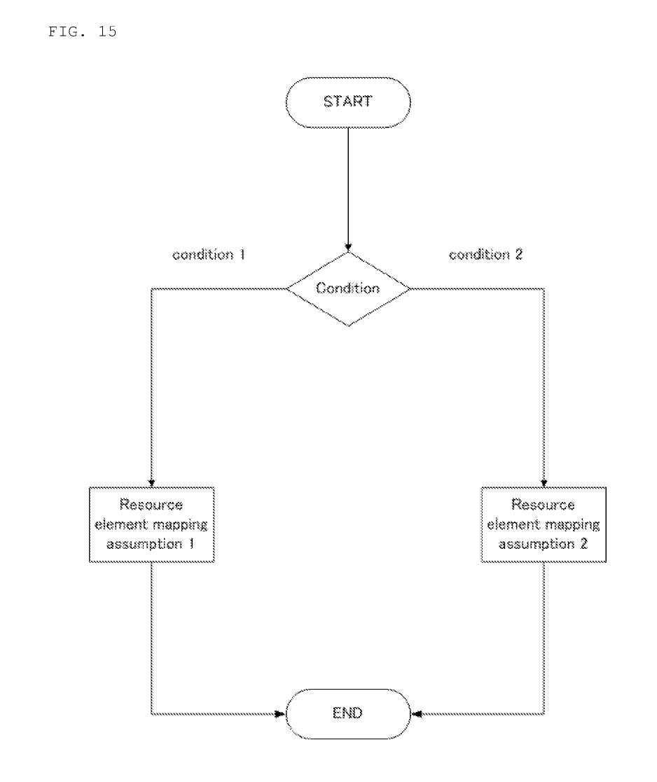

FIG. 15 illustrates a flow chart for the decision about the resource element mapping assumption. The mobile station device checks a given condition, which can be the value of a parameter, a measure of a quality of the channel, or something else (condition). If condition 1 is fulfilled the mobile station device works under resource element mapping assumption 1. If condition 2 is fulfilled the mobile station device works under resource element mapping assumption 2.

The figure illustrates only two conditions, but in some cases there are three, four, or more different outcomes depending on a set of conditions. This figure is also used for those cases, understanding that an extension of it to accommodate the multiplicity of possible conditions is a trivial exercise. Alternatively, those cases can be though as a series of binary conditions, in which condition 1 corresponds to a single condition and condition 2 corresponds to all the remaining conditions together. If condition 2 is chosen, the process is repeated using one of them as the new condition 1, and the remaining ones as condition 2.

The mobile station device checks the condition at a given rate, which can be, for example, every subframe, every radio frame, every time a pre-defined event occurs, etc. The resource element mapping assumptions 1, 2, . . . shown in the flow chart can be different each time the condition is checked.

The resource element mapping assumption can be defined in terms of number of CRS, CRS position, CRS presence, CSI-RS position, CSI-RS configuration, CFI value and/or starting OFDM symbol for EPDCCH.

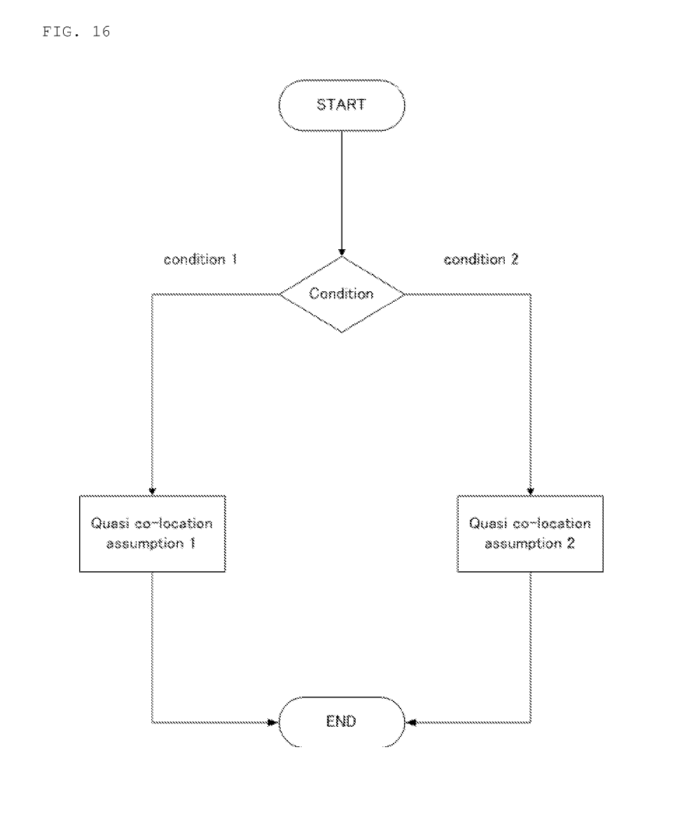

FIG. 16 illustrates a flow chart for the decision about the quasi co-location assumption. The mobile station device checks a given condition, which can be the value of a parameter, a measure of a quality of the channel, or something else (condition). If condition 1 is fulfilled the mobile station device works under quasi co-location assumption 1. If condition 2 is fulfilled the mobile station device works under quasi co-location assumption 2.

The figure illustrates only two conditions, but in some cases there are three, four, or more different outcomes depending on a set of conditions. This figure is also used for those cases, understanding that an extension of it to accommodate the multiplicity of possible conditions is a trivial exercise. Alternatively, those cases can be though as a series of binary conditions, in which condition 1 corresponds to a single condition and condition 2 corresponds to all the remaining conditions together. If condition 2 is chosen, the process is repeated using one of them as the new condition 1, and the remaining ones as condition 2.

The mobile station device checks the condition at a given rate, which can be, for example, every subframe, every radio frame, every time a pre-defined event occurs, etc. The quasi co-location assumptions 1, 2, . . . shown in the flow chart can be different each time the condition is checked.

The quasi co-location assumption can be defined in terms of resource (e.g. CSI-RS, CRS, tracking RS, synchronization signal, discovery signal) that is quasi co-located with the antenna ports for PDCCH/EPDCCH/PDSCH, and/or quasi co-location behavior to be used by mobile station device (type A and type B).

The condition explained in the previous flow charts can be defined by one or more parameters that are configured/notified through RRC, PDCCH, EPDCCH, MIB, and/or SIB. For example, the condition can be defined by transmission mode, higher layer configuration, and/or subframe configuration.

In one embodiment of the invention the size and/or the location of the ePDCCH-set 2 are explicitly transmitted by the base station device to the mobile station devices. For example, the detailed configuration of each subframe in a radio frame is obtained through a bitmap.

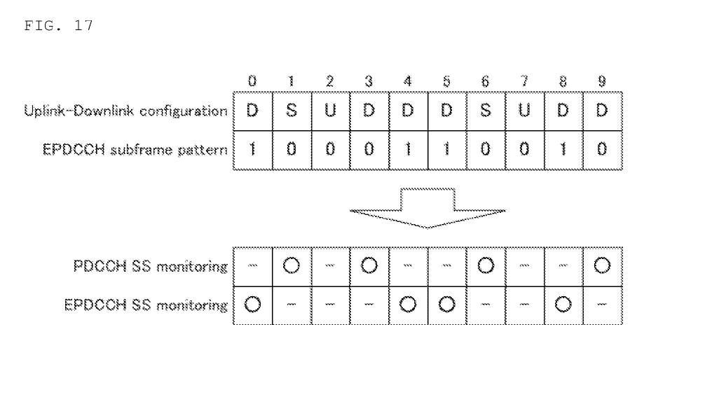

FIG. 17 illustrates an example in which the presence of ePDCCH SS (Search Space) is conveyed by the base station device through an EPDCCH indication, in this example in the form of “EPDCCH subframe pattern”. For example, the “EPDCCH subframe pattern” can be bitmap information of a given number of bits, e.g. 10, 40, etc.

The term “PDCCH SS” can refer to CSS, USS, or to both of them. The term “EPDCCH SS” can refer to eCSS, eUSS, or to both of them. In the following the exemplary case in which “PDCCH SS” and “EPDCCH SS” correspond to PDCCH CSS and EPDCCH CSS respectively is treated. The invention is not restricted to this example, any combination of CSS, USS, eCSS, eUSS is also considered.

In the figure the uplink-downlink configuration of a radio frame and a 10 bit bitmap “EPDCCH subframe pattern” corresponding to that radio frame are shown. The bitmap is set to 1 in the subframes in which the mobile station devices are expected to monitor the ePDCCH SS. The bitmap is set to 0 in the subframes in which the mobile station devices are not expected to monitor the ePDCCH SS.

In the example, the mobile station devices do not monitor the PDCCH SS if they monitor the ePDCCH SS. Increasing the number of blind decoding that a mobile station device is expected to perform at a given subframe increases the overall complexity of the system. Therefore, in order to keep the complexity at a level as close as possible to current systems, the mobile station devices monitor either the PDCCH SS or the ePDCCH SS, but not both of them. This is not a constraint of the invention. In another example the mobile station devices may monitor both the PDCCH SS and the EPDCCH SS in the same subframe.

The mobile station devices monitor the PDCCH CSS in the downlink subframes (including the special subframes) that are not configured for ePDCCH CSS.

Following the resource element mapping assumption flow chart, condition 1 corresponds with EPDCCH subframe pattern being set to 1, and condition 2 corresponds to EPDCCH subframe pattern being set to 0 in a downlink subframe. Under condition 1, the mobile station device assumes resource element mapping 1 (resource element mapping around CRS and/or other reference signals). Under condition 2 the mobile station device assumes resource element mapping 2 (no CRS or reduced CRS presence in the subframe).

Following the quasi co-location assumption flow chart, conditions 1 and 2 corresponds with the conditions 1 and 2 described above. The quasi co-location assumption derived from each of these conditions depends on other considerations of the system.

In one example both conditions lead to the same quasi co-location assumption.

In another example the mobile station device receives two PQI. In this case condition 1 leads to quasi co-location assumption 1, in which the quasi co-location assumption corresponds with one of the received PQIs. Condition 2 leads to quasi co-location assumption 2, in which the quasi co-location assumption corresponds with the other received PQI.

Another embodiment of the invention would involve the mobile station devices to always monitor the PDCCH SS, and, in addition, monitor the ePDCCH SS according to a bitmap.

If the mobile station device is configured with EPDCCH subframe pattern and EPDCCH monitoring, the mobile station device determines the resource element mapping and/or the quasi co-location assumption depending on the subframe indicated by Uplink-Downlink configuration and EPDCCH subframe pattern.

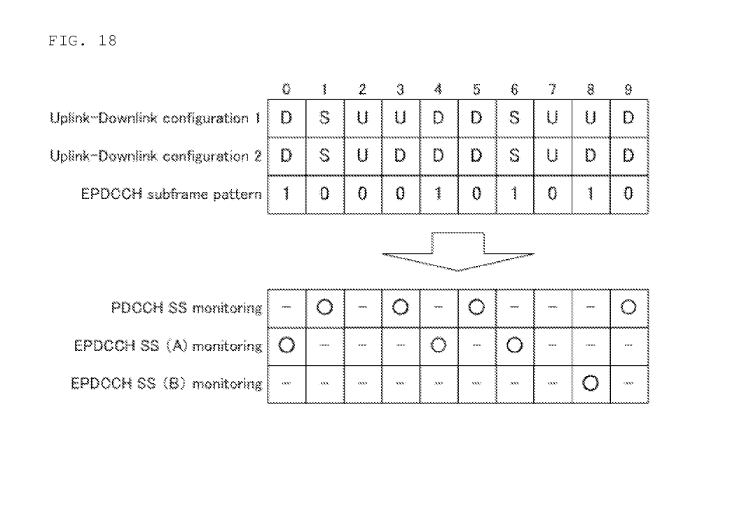

FIG. 18 illustrates an example in which some of the subframes are configured as flexible subframes.

The flexible subframes are defined as explained before by the double configuration set Uplink-Downlink configuration 1 and Uplink-Downlink configuration 2. In the example of the figure the following subframes are configured as flexible: subframe #3, and subframe #8. The ePDCCH subframe pattern indicates in which subframes the mobile station devices are expected to monitor ePDCCH SS.

Following the resource element mapping assumption flow chart condition 1 corresponds to EPDCCH subframe pattern being set to 1 in a legacy subframe and condition 2 corresponds to EPDCCH subframe pattern being set to 1 in a flexible subframe. Under condition 1 (legacy subframe), the mobile station device assumes resource element mapping 1 (resource element mapping around CRS and/or other reference signals). Under condition 2 (flexible subframe) the mobile station device assumes resource element mapping 2 (no CRS or reduced CRS presence in the subframe).

In addition, the mobile station devices perform PDCCH SS monitoring in the subframes that are configured for downlink and in which EPDCCH monitoring is not expected. This includes the flexible subframes for which the mobile station device does not have an uplink scheduling grant. The mobile station does not know if the flexible subframe is used for uplink by another mobile station device or for downlink, and therefore the PDSCCH needs to be monitored. This can be considered as condition 3.

Following the quasi co-location assumption flow chart, condition 1 corresponds to EPDCCH subframe pattern being set to 1 in a legacy subframe, condition 2 corresponds to EPDCCH subframe pattern being set to 1 in a flexible subframe, and condition 3 corresponds to a downlink subframe in which EPDCCH subframe pattern is set to 0. The quasi co-location assumption derived from each of these conditions depends on other considerations of the system.

In one example the mobile station device receives only one PQI. In this case condition 1 and condition 3 lead to quasi co-location assumption 1 in which the quasi co-location assumption corresponds with the received PO. Condition 2 corresponds with a parameter set equivalent to the received PQI in all the parameters except in those related to resource element mapping, which are overridden to adequate to the non-CRS/CRS-reduced operation.

In another example the mobile station device receives two PQI values. In this case condition 1 and condition 3 lead to quasi co-location assumption 1, in which the quasi co-location assumption corresponds with one of the received PQIs. Condition 2 leads to quasi co-location assumption 2, in which the quasi co-location assumption corresponds with the other received PQI.

In another example the mobile station device receives three PQI values, each condition leading to a different quasi co-location assumption.

If the mobile station device is configured with EPDCCH subframe pattern, Uplink-Downlink configuration 2 and EPDCCH monitoring, the mobile station device determines the resource element mapping and/or the quasi co-location assumption depending on the subframe indicated by Uplink-Downlink configuration 1, Uplink-Downlink configuration 2, and EPDCCH subframe pattern.

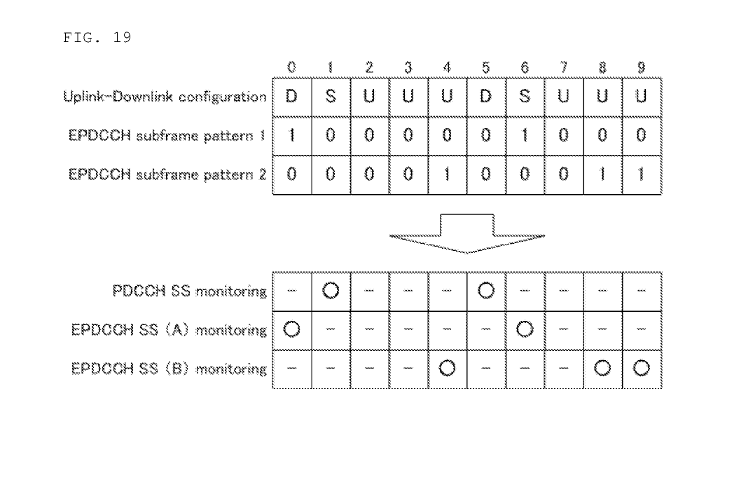

FIG. 19 illustrates another example case in which the base station mobile device transmits a bitmap to indicate in which subframes the mobile station devices are expected to monitor the ECSS with resource element mapping around legacy CRS. In addition, the base station device transmits another bitmap to indicate in which subframes the mobile station devices are expected to monitor the ECSS with reduced or non-existent CRS.

Following the resource element mapping assumption flow chart, condition 1 corresponds to EPDCCH subframe pattern 1 being set to 1. In this case the mobile station device assumes resource element mapping around the CRS (resource element mapping assumption 1). Condition 2 corresponds to EPDCCH subframe pattern 2 being set to 1, and in this case the mobile station device assumes resource element mapping for subframes in which CRS is not present or its presence is reduced. Additionally, condition 3 can be defined as the cases in which all the bitmaps are set to 0 and the subframe is configured as downlink or as special subframe. In this case the mobile station device monitors the search space of the PDCCH.

Following the quasi co-location assumption flow chart, conditions 1, 2 and 3 are the same conditions as described above. The quasi co-location assumption derived from each of these conditions depends on other considerations of the system.

In one example the mobile station device receives only one PQI. In this case condition 1 and condition 3 lead to quasi co-location assumption 1 in which the quasi co-location assumption corresponds with the received PQI, Condition 2 corresponds with a parameter set equivalent to the received PQI in all the parameters except in those related to resource element mapping, which are overridden to adequate to the non-CRS/CRS-reduced operation.

In another example the mobile station device receives two PQI values. In this case condition 1 and condition 3 lead to quasi co-location assumption 1, in which the quasi co-location assumption corresponds with one of the received PQIs. Condition 2 leads to quasi co-location assumption 2, in which the quasi co-location assumption corresponds with the other received PQI.

In another example the mobile station device receives three PQI values, each condition leading to a different quasi co-location assumption.

In another embodiment of the invention the mapping is done via more than 1 bit. Each position of the mapping sequence gives the configuration of the ECSS for the corresponding subframe from a plurality of options.

If the mobile station device is configured with EPDCCH subframe pattern 1, EPDCCH subframe pattern 2 and EPDCCH monitoring, the mobile station device determines the resource element mapping and/or the quasi co-location assumption depending on the subframe indicated by Uplink-Downlink configuration, Uplink-Downlink configuration 2, EPDCCH subframe pattern 1 and EPDCCH subframe pattern 2.

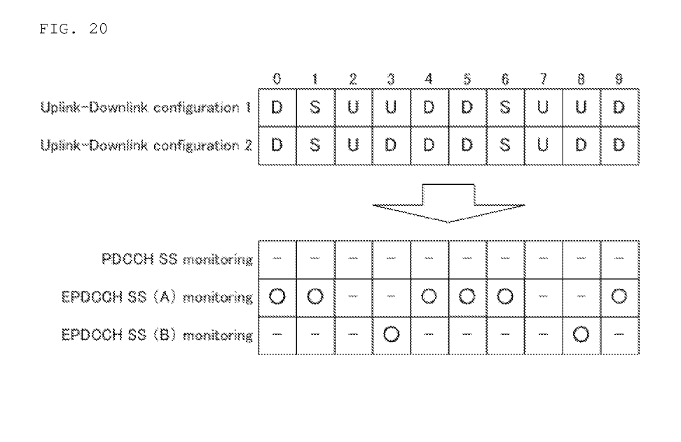

FIG. 20 illustrates a case in which the mobile station device implicitly assumes which subframes to monitor. The mobile station device monitors the EPDCCH SS for downlink subframes, special subframes, and flexible subframes for which the mobile station device does not have an uplink grant. The mobile station device does not monitor the PDCCH SS. The resource element mapping and the quasi co-location is also implicitly assumed.

Following the resource element mapping assumption flow chart, condition 1 corresponds to downlink or special legacy subframes. In this case the mobile station device assumes resource element mapping around the CRS (resource element mapping assumption 1). Condition 2 corresponds to flexible subframes for which the mobile station does not have an uplink grant, and in this case the mobile station device assumes resource element mapping for subframes in which CRS is not present or its presence is reduced.

Following the quasi co-location assumption flow chart, conditions 1 and 2 are the same conditions as described above. The quasi co-location assumption derived from each of these conditions depends on other considerations of the system.

In one example the mobile station device receives only one PQI. In this case condition 1 leads to quasi co-location assumption 1 in which the quasi co-location assumption corresponds with the received PQI. Condition 2 corresponds with a parameter set equivalent to the received PQI in all the parameters except in those related to resource element mapping, which are overridden to adequate to the non-CRS/CRS-reduced operation.

In another example the mobile station device receives two PQI values. In this case condition 1 leads to quasi co-location assumption 1, in which the quasi co-location assumption corresponds with one of the received PQIs. Condition 2 leads to quasi co-location assumption 2, in which the quasi co-location assumption corresponds with the other received PQI.

If the mobile station device is configured with Uplink-Downlink configuration 2 and EPDCCH monitoring, the mobile station device determines the resource element mapping and/or the quasi co-location assumption depending on the subframe indicated by Uplink-Downlink configuration 1 and Uplink-Downlink configuration 2. For example, the mapping in the resource element mapping assumption 1 is performed in consideration of CRS of serving cell or CRS indicated by higher layer signaling, the mapping in the resource element mapping assumption 2 is performed in consideration of no CRS or CRS indicated by higher layer signaling.

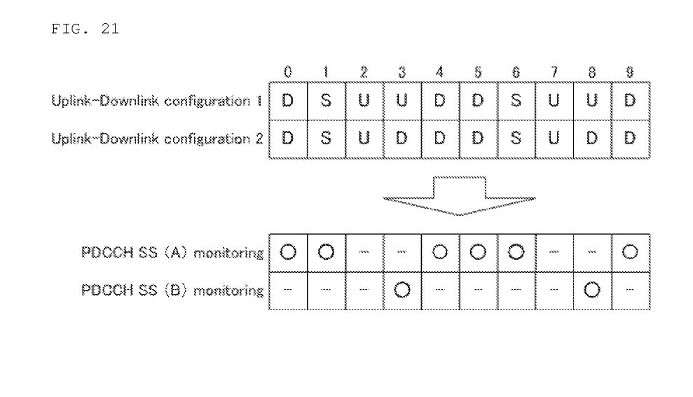

FIG. 21 illustrates a case in which the mobile station device monitors only the PDCCH SS, but the resource element mapping and the quasi co-location assumptions can vary and are implicit with other parameters of the system. Even though PDCCH requires CRS to be retrievable, it is possible to define a case in with reduced CRS and complete absence of other reference signals in the PDCCH region.

Following the resource element mapping assumption flow chart, condition 1 corresponds to downlink or special legacy subframes. In this case the mobile station device assumes resource element mapping around the CRS (resource element mapping assumption 1). Condition 2 corresponds to flexible subframes for which the mobile station device does not have an uplink grant, and in this case the mobile station device assumes resource element mapping for subframes with reduced or absent CRS and absence of other reference signals.

Following the quasi co-location assumption flow chart, conditions 1 and 2 are the same conditions as described above. The quasi co-location assumption derived from each of these conditions depends on other considerations of the system.

In one example the mobile station device receives only one PQI. In this case condition 1 leads to quasi co-location assumption 1 in which the quasi co-location assumption corresponds with the received PQI. Condition 2 corresponds with a parameter set equivalent to the received PQI in all the parameters except in those related to resource element mapping, which are overridden to adequate to the non-CRS/CRS-reduced operation.

In another example the mobile station device receives two PQI values. In this case condition 1 leads to quasi co-location assumption 1, in which the quasi co-location assumption corresponds with one of the received PQIs. Condition 2 leads to quasi co-location assumption 2, in which the quasi co-location assumption corresponds with the other received PQI.

If the mobile station device is configured with Uplink-Downlink configuration 2 and if the mobile station device is not configured with EPDCCH monitoring, the mobile station device determines the resource element mapping and/or the quasi co-location assumption depending on the subframe indicated by Uplink-Downlink configuration 1 and Uplink-Downlink configuration 2.

In another embodiment of the invention the bitmap is fixed. The subframes carrying ECSS in a TDD configuration are always the same. The base station mobile device transmits the common control information in these subframes, and the mobile station devices monitor them. Any alternate case in which the base station device uses for data the PRBs that are not used for ECSS in these subframes as explained above is also applicable in this case.

In one embodiment of the invention the base station device includes the ECSS information in the MIB (Master Information Block), which is updated every forty ms and transmitted every ten ms in the BCH (Broadcast Channel). The mobile station devices read this field during the initial access procedure and start monitoring the ECSS. Alternatively, the MIB contains an index that gives the pre-defined configuration from a plurality of options. The options can vary depending on the bandwidth of the system. Alternatively, the MIB contains a flag to signal the existence of this information in another segment, such as in a PDSCH or in an SIB.

In another embodiment of the invention the base station device includes this information in a specific SIB (System Information Block). The SIBs are transmitted in the DL-SCH (DownLink Shared Channel) along with other data. Alternatively, the parameters needed to identify and decode the ECSS are transmitted as a complement of an existing SIB.

In addition, the common information or the existence of it in another pre-defined location may be transmitted combining the MIB, the SIB, and/or some explicit methods such as RRC signaling.

In another embodiment of the invention the ECSS configuration information is transmitted through RRC messaging.

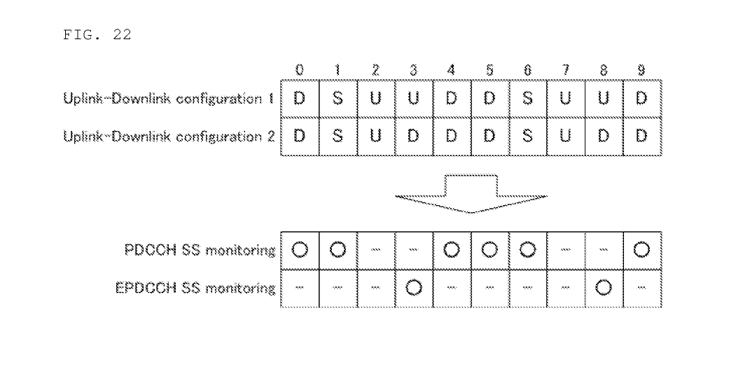

FIG. 22 illustrates a case in which the mobile station device implicitly assumes which subframes to monitor. The mobile station device monitors the PDCCH SS for downlink subframes and special subframes (configured as D or S in both uplink-downlink configuration 1 and uplink-downlink configuration 2). The mobile station device monitors EPDCCH SS for flexible subframes for which the mobile station device does not have an uplink grant. The resource element mapping and the quasi co-location is also implicitly assumed.

Following the resource element mapping assumption flow chart, condition 1 corresponds to legacy downlink or special subframes. In this case the mobile station device assumes resource element mapping around the CRS (resource element mapping assumption 1). Condition 2 corresponds to flexible subframes for which the mobile station does not have an uplink grant, and in this case the mobile station device assumes resource element mapping for subframes in which CRS is not present or its presence is reduced.

Following the quasi co-location assumption flow chart, conditions 1 and 2 are the same conditions as described above. The quasi co-location assumption derived from each of these conditions depends on other considerations of the system.

In one example the mobile station device receives only one PQI. In this case condition 1 leads to quasi co-location assumption 1 in which the quasi co-location assumption corresponds with the received PQI. Condition 2 corresponds with a parameter set equivalent to the received PQI in all the parameters except in those related to resource element mapping, which are overridden to adequate to the non-CRS/CRS-reduced operation.

In another example the mobile station device receives two PQI values. In this case condition 1 leads to quasi co-location assumption 1, in which the quasi co-location assumption corresponds with one of the received PQIs. Condition 2 leads to quasi co-location assumption 2, in which the quasi co-location assumption corresponds with the other received PQI.

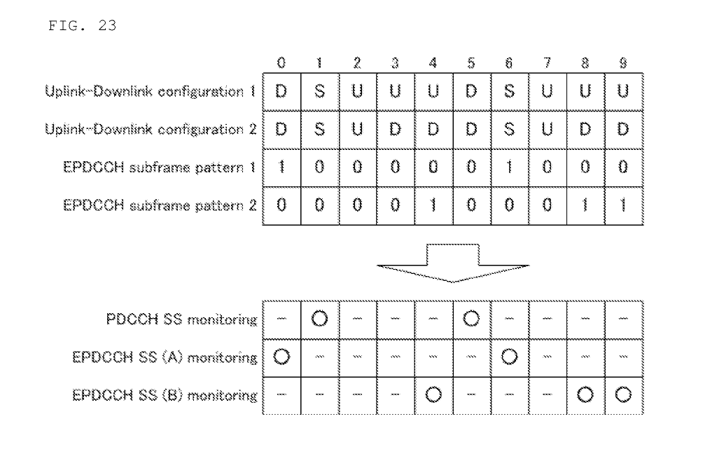

FIG. 23 illustrates a case in which the base station device transmits multiple bitmaps to indicate in which subframes the mobile station devices are expected to monitor the ECSS with determined conditions. The figure shows an example in which two bitmaps are transmitted, corresponding to FOSS conditions A and ECSS conditions B.

The mobile station device monitors the PDCCH SS in those subframes for which Uplink-Downlink configuration 1 and Uplink-Downlink configuration 2 are both set to D or S and EPDCCH subframe pattern 1 and EPDCCH subframe pattern 2 both set to 0. The mobile station device monitors the EPDCCH SS with conditions (A) in those subframes for which Uplink-Downlink configuration 1 and Uplink-Downlink configuration 2 are both set to D or S and EPDCCH subframe pattern 1 is set to 1 while EPDCCH subframe pattern 2 is set to 0. The mobile station device monitors the EPDCCH SS with conditions (B) in those subframes for which Uplink-Downlink configuration 1 and Uplink-Downlink configuration 2 are both set to D or S and EPDCCH subframe pattern 1 is set to 0 while EPDCCH subframe pattern 2 is set to 1.

Following the resource element mapping assumption flow chart, condition 1 corresponds to Uplink-Downlink configuration 1 and Uplink-Downlink configuration 2 both set to D or S and EPDCCH subframe pattern 1 and FPDCCH subframe pattern 2 both set to 0. In this case the mobile station device assumes resource element mapping around the CRS (resource element mapping assumption 1). Condition 2 corresponds to Uplink-Downlink configuration 1 and Uplink-Downlink configuration 2 both set to D or S and EPDCCH subframe pattern 1 is set to 1 while EPDCCH subframe pattern 2 is set to 0, and in this case the mobile station device assumes resource element mapping for subframes in which CRS is not present or its presence is reduced according to the conditions (A). Condition 3 corresponds to Uplink-Downlink configuration 1 and Uplink-Downlink configuration 2 both set to D or S and EPDCCH subframe pattern 1 is set to 1 while EPDCCH subframe pattern 2 is set to 0, and in this case the mobile station device assumes resource element mapping for subframes in which CRS is not present or its presence is reduced according to (B).

Following the quasi co-location assumption flow chart, conditions 1, 2 and 3 are the same conditions as described above. The quasi co-location assumption derived from each of these conditions depends on other considerations of the system.

In one example the mobile station device receives only one PQI. In this case condition 1 and condition 3 lead to quasi co-location assumption 1 in which the quasi co-location assumption corresponds with the received PQI. The rest of the conditions (for instance condition 2) correspond with a parameter set equivalent to the received PQI in all the parameters except in those related to resource element mapping, which are overridden to adequate to the non-CRS/CRS-reduced operation.

In another example the mobile station device receives two PQI values. In this case condition 1 and condition 3 lead to quasi co-location assumption 1, in which the quasi co-location assumption corresponds with one of the received PQIs. Condition 2 leads to quasi co-location assumption 2, in which the quasi co-location assumption corresponds with the other received PQI.

In another example the mobile station device receives three PQI values, each condition leading to a different quasi co-location assumption.

In another embodiment of the invention the mapping is done via more than 1 bit. Each position of the mapping sequence gives the configuration of the ECSS for the corresponding subframe from a plurality of options.

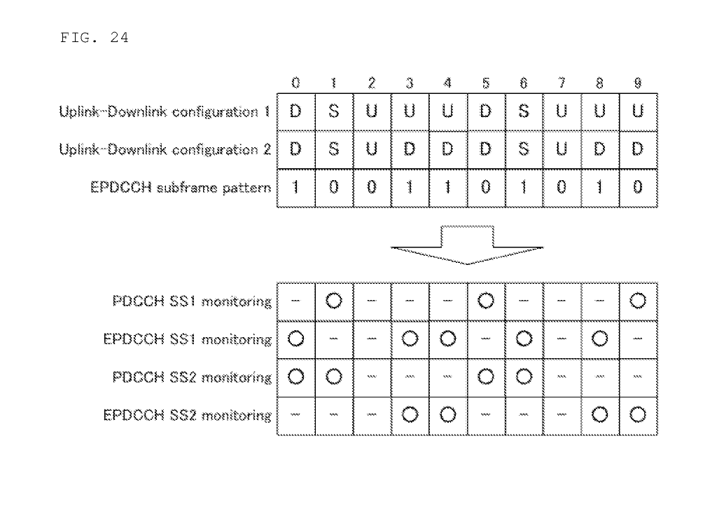

FIG. 24 illustrates an example in which some of the subframes are configured as flexible subframes.

The flexible subframes are defined as explained before by the double configuration set Uplink-Downlink configuration 1 and Uplink-Downlink configuration 2. In the example of the figure the following subframes are configured as flexible: subframe #3, subframe #4, subframe #8, and subframe #9. The mobile station devices are expected to monitor PDCCH SS1 if EPDCCH subframe pattern is set to 0, and EPDCCH SS1 if EPDCCH subframe pattern is set to 1. Additionally, the mobile station devices are expected to monitor PDCCH SS2 in non-uplink legacy subframes. The mobile station devices are expected to monitor EPDCCH SS2 in flexible subframes for which they don't have an uplink grant.

Following the resource element mapping assumption flow chart, condition 1 corresponds to EPDCCH subframe pattern being set to 0 in a legacy subframe, in which case the mobile station devices are expected to monitor PDCCH SS1 and PDCCH SS2. Condition 2 corresponds to EPDCCH subframe pattern being set to 1 in a legacy subframe, and the mobile station devices are expected to monitor EPDCCH SS1 and PDCCH SS2. Condition 3 corresponds to EPDCCH subframe pattern being set to 0 in a flexible subframe, and the mobile station devices are expected to monitor PDCCH SS1 and EPDCCH SS2. Condition 4 corresponds to EPDCCH subframe pattern being set to 1 in a flexible subframe, and the mobile station devices are expected to monitor EPDCCH SS1 and EPDCCH SS2.

Following the quasi co-location assumption flow chart, condition 1 corresponds to EPDCCH subframe pattern being set to 0 in a legacy subframe, condition 2 corresponds to EPDCCH subframe pattern being set to 1 in a legacy subframe, condition 3 corresponds to EPDCCH subframe pattern being set to 0 in a flexible subframe, and condition 4 corresponds to EPDCCH subframe pattern being set to 1 in a flexible subframe. The quasi co-location assumption derived from each of these conditions depends on other considerations of the system.

In one example the mobile station device receives only one PQI. In this case some of the conditions (for instance condition 1 and condition 3, or condition 4, etc.) lead to quasi co-location assumption 1 in which the quasi co-location assumption corresponds with the received PQI. The rest of the conditions (for instance condition 2) correspond with a parameter set equivalent to the received PQI in all the parameters except in those related to resource element mapping, which are overridden to adequate to the non-CRS/CRS-reduced operation.

In another example the mobile station device receives two PQI values. In this case some of the conditions (for instance condition 1 and condition 3, or condition 2, etc.) lead to quasi co-location assumption 1, in which the quasi co-location assumption corresponds with one of the received PQIs. Some other conditions (for instance condition 4) lead to quasi co-location assumption 2, in which the quasi co-location assumption corresponds with the other received PQI.

In another example the mobile station device receives three PQI values. In this case some of the conditions (for instance condition 1 and condition 3, or condition 2, etc.) lead to quasi co-location assumption 1, in which the quasi co-location assumption corresponds with one of the received PQIs. Some other conditions (for instance condition 4) lead to quasi co-location assumption 2, in which the quasi co-location assumption corresponds with another received PQI. Some other conditions (for instance condition 2) lead to quasi co-location assumption 3, in which the quasi co-location assumption corresponds with the other received PQI.

In another example the mobile station device receives four PQI values, each condition leading to a different quasi co-location assumption.

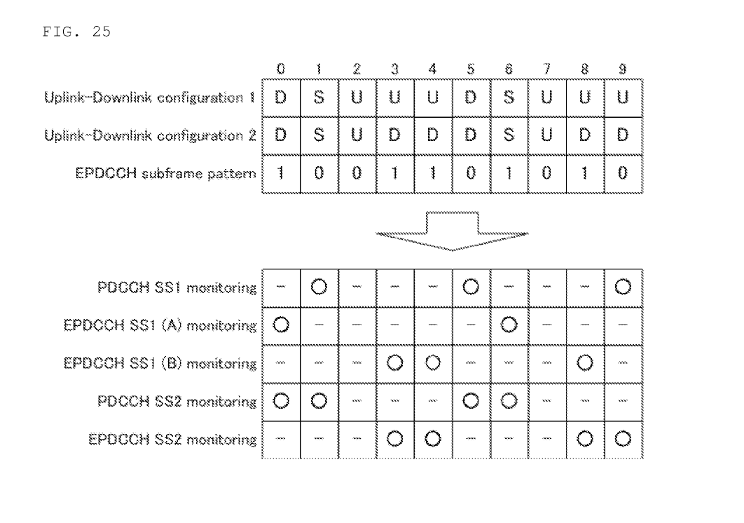

FIG. 25 illustrates an example in which some of the subframes are configured as flexible subframes.

The flexible subframes are defined as explained before by the double configuration set Uplink-Downlink configuration 1 and Uplink-Downlink configuration 2. In the example of the figure the following subframes are configured as flexible: subframe #3, subframe #4, subframe #8, and subframe #9. The mobile station devices are expected to monitor PDCCH 881 in a legacy subframe for which EPDCCH subframe pattern is set to 0, EPDCCH SS1 with configuration (A) in legacy subframes for which EPDCCH subframe pattern is set to 1, and EPDCCH SS1 with configuration (E) in legacy subframes for which EPDCCH subframe pattern is set to 1. Additionally, the mobile station devices are expected to monitor PDCCH SS2 in non-uplink legacy subframes. The mobile station devices are expected to monitor EPDCCH SS2 in flexible subframes for which they don't have an uplink grant.

Following the resource element mapping assumption flow chart, condition 1 corresponds to EPDCCH subframe pattern being set to 0 in a legacy subframe, in which case the mobile station devices are expected to monitor PDCCH SS1. Condition 2 corresponds to EPDCCH subframe pattern being set to 1 in a legacy subframe, and the mobile station devices are expected to monitor EPDCCH SS1 under configuration (A). Condition 3 corresponds to EPDCCH subframe pattern being set to 1 in a flexible subframe, and the mobile station devices are expected to monitor EPDCCH SS1 under configuration (B). Condition 4 corresponds to a legacy subframe, and the mobile station devices are expected to monitor PDCCH SS2. Condition 5 corresponds to a flexible subframe, and the mobile station devices are expected to monitor EPDCCH SS2.

Following the quasi co-location assumption flow chart, condition 1 corresponds to EPDCCH subframe pattern being set to 0 in a legacy subframe, condition 2 corresponds to EPDCCH subframe pattern being set to 1 in a legacy subframe, condition 3 corresponds to EPDCCH subframe pattern being set to 1 in a flexible subframe, condition 4 corresponds to a legacy subframe, and condition 5 corresponds to a flexible subframe. The quasi co-location assumption derived from each of these conditions depends on other considerations of the system.

In one example the mobile station device receives only one PQI. In this case some of the conditions (for instance condition 1 and condition 3, or condition 4, etc.) lead to quasi co-location assumption 1 in which the quasi co-location assumption corresponds with the received PQI. The rest of the conditions (for instance condition 2) correspond with a parameter set equivalent to the received PQI in all the parameters except in those related to resource element mapping, which are overridden to adequate to the non-CRS/CRS-reduced operation.

In another example the mobile station device receives two PQI values. In this case some of the conditions (for instance condition 1 and condition 3, or condition 2, etc.) lead to quasi co-location assumption 1, in which the quasi co-location assumption corresponds with one of the received PQIs. Some other conditions (for instance condition 4) lead to quasi co-location assumption 2, in which the quasi co-location assumption corresponds with another received PQI.

In another example the mobile station device receives three PQI values. In this case some of the conditions (for instance condition 1 and condition 3, or condition 2, etc.) lead to quasi co-location assumption 1, in which the quasi co-location assumption corresponds with one of the received PQIs. Some other conditions (for instance condition 4) lead to quasi co-location assumption 2, in which the quasi co-location assumption corresponds with another received PQI. Some other conditions (for instance condition 2) lead to quasi co-location assumption 3, in which the quasi co-location assumption corresponds with the other received PQI.

In another example the mobile station device receives four PQI values. In this case some of the conditions (for instance condition 1 and condition 3, or condition 2, etc.) lead to quasi co-location assumption 1, in which the quasi co-location assumption corresponds with one of the received PQIs. Some other conditions (for instance condition 4) lead to quasi co-location assumption 2, in which the quasi co-location assumption corresponds with another received PQI. Some other conditions (for instance condition 2) leads to quasi co-location assumption 3, in which the quasi co-location assumption corresponds with another received PQI. Some other conditions (for instance condition 5) lead to quasi co-location assumption 4, in which the quasi co-location assumption corresponds with the other received PQI.

In another example the mobile station device receives five PQI values, each condition leading to a different quasi co-location assumption.

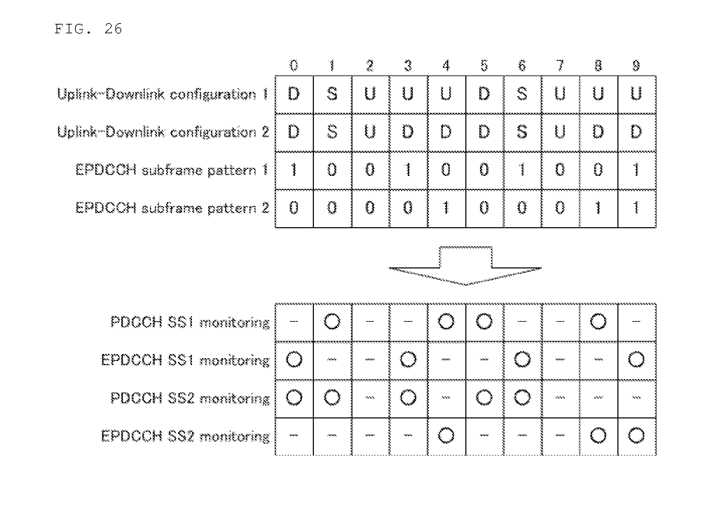

FIG. 26 illustrates a case in which the base station device transmits multiple bitmaps to indicate in which subframes the mobile station devices are expected to monitor EPDCCH in multiple different search spaces. The figure shows an example in which two bitmaps are transmitted, corresponding to PDCCH/EPDCCH in SS1 and PDCCH/EPDCCH in SS2.

The mobile station device monitors the PDCCH SS1 in legacy and flexible subframes in which EPDCCH subframe pattern 1 is set to 0. The mobile station device monitors the EPDCCH SS1 in legacy and flexible subframes in which EPDCCH subframe pattern 1 is set to 1. In addition, the mobile station device monitors the PDCCH SS2 in legacy and flexible subframes in which EPDCCH subframe pattern 2 is set to 0. The mobile station device monitors the EPDCCH SS2 in legacy and flexible subframes in which EPDCCH subframe pattern 2 is set to 1.

Following the resource element mapping assumption flow chart, condition 1 corresponds to both EPDCCH subframe pattern 1 and EPDCCH subframe pattern 2 being set to 0 in a legacy or flexible subframe, and in this case the mobile station device assumes resource element mapping for subframes in which CRS is present in both search spaces. Condition 2 corresponds to EPDCCH subframe pattern 1 being set to 1 while EPDCCH subframe pattern 2 is set to 0, and in this case the mobile station device assumes resource element mapping for subframes in which CRS is present in the SS1 and resource element mapping for subframes in which CRS is not present or its presence is reduced in the SS2. Condition 3 corresponds to EPDCCH subframe pattern 1 being set to 0 while EPDCCH subframe pattern 2 is set to 1, and in this case the mobile station device assumes resource element mapping for subframes in which CRS is not present or its presence is reduced in the SS1 and resource element mapping for subframes in which CRS is present in the SS2. Condition 4 corresponds to both EPDCCH subframe pattern 1 and EPDCCH subframe pattern 2 being set to 1, and in this case the mobile station device assumes resource element mapping for subframes in which CRS not present or its presence is reduced in both the SS1 and the SS2.

Following the quasi co-location assumption flow chart, conditions 1, 2, 3 and 4 are the same conditions as described above. The quasi co-location assumption derived from each of these conditions depends on other considerations of the system.

In one example the mobile station device receives only one PQI. In this case some of the conditions (for instance condition 1 and condition 3, or condition 4, etc.) lead to quasi co-location assumption 1 in which the quasi co-location assumption corresponds with the received PQI. The rest of the conditions (for instance condition 2) correspond with a parameter set equivalent to the received PQI in all the parameters except in those related to resource element mapping, which are overridden to adequate to the non-CRS/CRS-reduced operation.

In another example the mobile station device receives two PQI values. In this case some of the conditions (for instance condition 1 and condition 3, or condition 2, etc.) lead to quasi co-location assumption 1, in which the quasi co-location assumption corresponds with one of the received PQIs. Some other conditions (for instance condition 4) lead to quasi co-location assumption 2, in which the quasi co-location assumption corresponds with another received PQI.

In another example the mobile station device receives three PQI values. In this case some of the conditions (for instance condition 1 and condition 3, or condition 2, etc.) lead to quasi co-location assumption 1, in which the quasi co-location assumption corresponds with one of the received PQIs. Some other conditions (for instance condition 4) lead to quasi co-location assumption 2, in which the quasi co-location assumption corresponds with another received PQI. Some other conditions (for instance condition 2) lead to quasi co-location assumption 3, in which the quasi co-location assumption corresponds with the other received PQT.

In another example the mobile station device receives four PQI values, each condition leading to a different quasi co-location assumption.

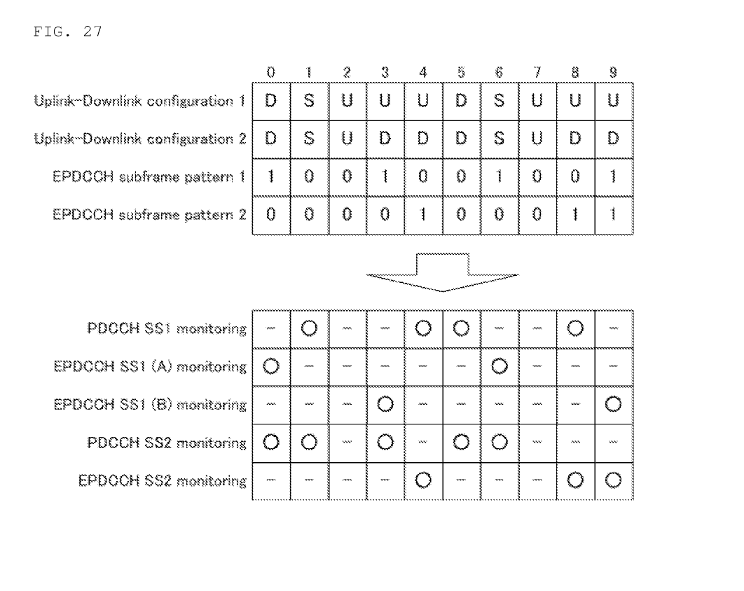

FIG. 27 illustrates an example in which some of the subframes are configured as flexible subframes and the base station device transmits multiple bitmaps to indicate in which subframes the mobile station devices are expected to monitor EPDCCH in multiple different search spaces. The figure shows an example in which two bitmaps are transmitted, corresponding to PDCCH/EPDCCH in SS1 and PDCCH/EPDCCH in SS2.

The flexible subframes are defined as explained before by the double configuration set Uplink-Downlink configuration 1 and Uplink-Downlink configuration 2. In the example of the figure the following subframes are configured as flexible: subframe #3, subframe #4, subframe #8, and subframe #9. The mobile station devices are expected to monitor PDCCH SS1 in a legacy subframe for which EPDCCH subframe pattern 1 is set to 0, EPDCCH SS1 with configuration (A) in legacy subframes for which EPDCCH subframe pattern 1 is set to 1, and EPDCCH SS1 with configuration (B) in legacy subframes for which EPDCCH subframe pattern 1 is set to 1. Additionally, the mobile station devices are expected to monitor PDCCH SS2 in subframes for which EPDCCH subframe pattern 2 is set to 0. The mobile station devices are expected to monitor EPDCCH SS2 in subframes for which EPDCCH subframe pattern 2 is set to 1 and they don't have an uplink grant.

Following the resource element mapping assumption flow chart, condition 1 corresponds to EPDCCH subframe pattern 1 being set to 0, in which case the mobile station devices are expected to monitor PDCCH SS1. Condition 2 corresponds to EPDCCH subframe pattern 1 being set to 1 in a legacy subframe, and the mobile station devices are expected to monitor EPDCCH SS1 under configuration (A). Condition 3 corresponds to EPDCCH subframe pattern being set to 1 in a flexible subframe, and the mobile station devices are expected to monitor EPDCCH SS1 under configuration (B). Condition 4 corresponds to a subframe in which EPDCCH subframe pattern 2 is set to 0, and the mobile station devices are expected to monitor PDCCH SS2. Condition 5 corresponds to a subframe in which EPDCCH subframe pattern 2 is set to 1, and the mobile station devices are expected to monitor EPDCCH SS2.

Following the quasi co-location assumption flow chart, condition 1 corresponds to EPDCCH subframe pattern 1 being set to 0, condition 2 corresponds to EPDCCH subframe pattern 1 being set to 1 in a legacy subframe, condition 3 corresponds to EPDCCH subframe pattern 1 being set to 1 in a flexible subframe, condition 4 corresponds to EPDCCH subframe pattern 2 being set to 0, and condition 5 corresponds to EPDCCH subframe pattern 2 being set to 1. The quasi co-location assumption derived from each of these conditions depends on other considerations of the system.

In one example the mobile station device receives only one PQI. In this case some of the conditions (for instance condition 1 and condition 3, or condition 4, etc.) lead to quasi co-location assumption 1 in which the quasi co-location assumption corresponds with the received PQI. The rest of the conditions (for instance condition 2) correspond with a parameter set equivalent to the received PQI in all the parameters except in those related to resource element mapping, which are overridden to adequate to the non-CRS/CRS-reduced operation.

In another example the mobile station device receives two PQI values. In this case some of the conditions (for instance condition 1 and condition 3, or condition 2, etc.) lead to quasi co-location assumption 1, in which the quasi co-location assumption corresponds with one of the received PQIs. Some other conditions (for instance condition 4) lead to quasi co-location assumption 2, in which the quasi co-location assumption corresponds with another received PQI.

In another example the mobile station device receives three PQI values. In this case some of the conditions (for instance condition 1 and condition 3, or condition 2, etc.) lead to quasi co-location assumption 1, in which the quasi co-location assumption corresponds with one of the received PQIs. Some other conditions (for instance condition 4) lead to quasi co-location assumption 2, in which the quasi co-location assumption corresponds with another received PQI. Some other conditions (for instance condition 2) lead to quasi co-location assumption 3, in which the quasi co-location assumption corresponds with the other received PQI.

In another example the mobile station device receives four PQI values. In this case some of the conditions (for instance condition 1 and condition 3, or condition 2, etc.) lead to quasi co-location assumption 1, in which the quasi co-location assumption corresponds with one of the received PQIs. Some other conditions (for instance condition 4) lead to quasi co-location assumption 2, in which the quasi co-location assumption corresponds with another received PQI. Some other conditions (for instance condition 2) leads to quasi cc-location assumption 3, in which the quasi co-location assumption corresponds with another received PQI. Some other conditions (for instance condition 5) lead to quasi co-location assumption 4, in which the quasi co-location assumption corresponds with the other received PQI.

In another example the mobile station device receives five PQI values, each condition leading to a different quasi co-location assumption.

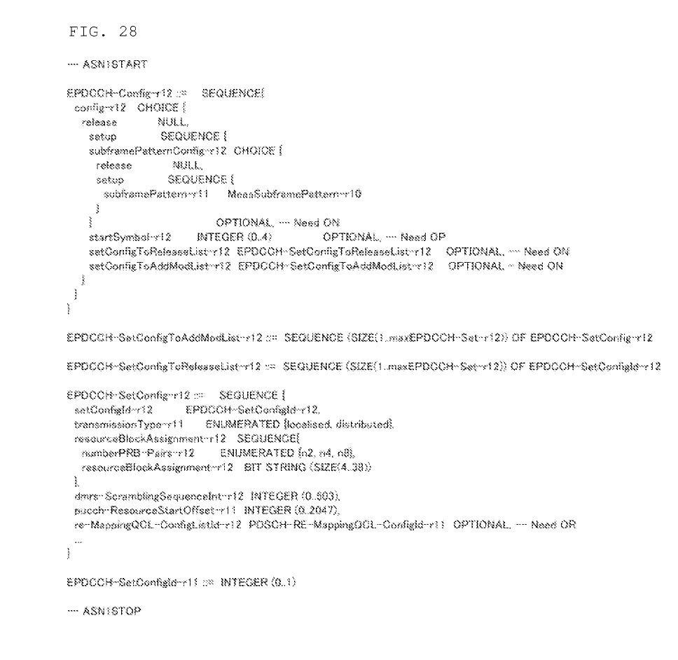

FIG. 28 shows an example of an information element that can be used for explicit indication of an eCSS ePDCCH-PRB-set. In particular, the information element is labeled as EPDCCH-Config-r12.

SubframePatternConfig-r12 includes a bitmap for forty subframes, indicating which subframes are configured for ePDCCH operation.

StartSymbol-r12 indicates the starting OFDM symbol for any ePDCCH and/or PDSCH scheduled by ePDCCH on the same cell in the first slot of a subframe. This field can be configured for mobile station devices configured with transmission mode 1-9. The configuration of the mobile station device is determined by the value of the parameter StartSymbol-r12 when it is configured. If the mobile station device is configured with the higher layer parameter StartSymbol-r12, the starting OFDM symbol for EPDCCH and/or PDSCH scheduled by ePDCCH given by index l_{EPDCCHstart} in the first slot in a subframe is determined from the higher layer parameter. Values 0, 1, 2, and 3 are applicable for downlink bandwidth greater than 10 resource blocks. Values 0, 2, 3, and 4 are applicable otherwise. Otherwise, the mobile station device releases the configuration and derives the starting OFDM symbol of ePDCCH and PDSCH scheduled by ePDCCH from the CFI (Control Format Indicator) value indicated by the PCFICH.

Moreover, if the mobile station device is configured with a given subframe configuration, the starting OFDM symbol for EPDCCH and/or PDSCH scheduled by ePDCCH can be determined depending on the type of subframe indicated by the subframe configuration as explained above, e.g. Uplink-Downlink configuration and/or EPDCCH subframe pattern.

EPDCCH-SetConfig-r12 includes the configuration information of the ePDCCH-PRB-sets dedicated for eUSS or eCSS. SetConfigId-r12 is the identity of the set and is initialized to 0, 1, or higher if the eCSS is configured in a separate ePDCCH-set. For example, eUSS is transmitted in the sets 0 and 1, and eCSS is transmitted in the set 2. TransmissionType-r11 indicates whether the transmission is localized or distributed. ResourceBlockAssignment-r12 includes the information of the PRBs used for the ePDCCH-PRB-set. The ePDCCH-PRB-set can span 2, 4, 8, or more PRBs, as indicated by numberPRB-Pairs-r12. Their position is given as the combinatorial index resourceBlockAssignment-r12. The DMRS scrambling sequence of the ePDCCH-PRB-set is given by dmrs-ScramblingSequenceInt-r12. The start offset for the HARQ response in the PUCCH is given in pucch-ResourceStartOffset-r11.

Re-MappingQCL-ConfigListId-r12 is configured for mobile station devices configured with transmission mode 10 or higher. The parameter set Re-MappingQCL-ConfigListId-r12 indicated by the higher layer parameter is determined for the EPDCCH resource element mapping and EPDCCH antenna port quasi co-location. The parameter set includes crs-PortsCount, crs-FreqShift, mbsfn-SubframeConfigList, csi-RS-ConfigZPId, pdsch-Start, and/or gcl-CSI-RS-ConfigNZPId. The CRS position for EPDCCH RE mapping is indicated by the parameters crs-PortsCount, crs-FreqShift, and mbsfn-SubframeConfigList. The CSI-RS position for EPDCCH RE mapping is indicated by the parameter csi-RS-ConfigZPId. The starting OFDM symbol for EPDCCH and/or PDSCH scheduled by ePDCCH is indicated by the parameter pdsch-Start. The parameter gcl-CSI-RS-ConfigNZPId indicates the CSI-RS resource that is quasi co-located with the PDSCH antenna ports. Value of the parameters crs-PortsCount can be 1, 2, 4, or 0.

If the value of the parameter pdsch-Start belongs to {1, 2, 3, 4}, the starting OFDM symbol for EPDCCH and/or PDSCH scheduled by ePDCCH is determined based on the parameter pdsch-Start. Otherwise, the starting OFDM symbol for EPDCCH and/or PDSCH scheduled by ePDCCH is determined based on the CFI (Control Format Indicator) value indicated by the PCFICH in the subframe.

Moreover, if the mobile station device is configured with a subframe configuration (for example subframe type indication, Uplink-Downlink configuration and/or EPDCCH subframe pattern) the resource element mapping assumption with regard to CRS, CSI-RS, or starting OFDM symbol for EPDCCH and/or PDSCH scheduled by ePDCCH can be determined depending on the type of subframe indicated by the subframe configuration.

An example of antenna ports quasi co-location for EPDCCH is explained.

For a given serving cell, if the UE is configured via higher layer signalling to receive PDSCH data transmissions according to transmission modes 1-9, and if the UE is configured to monitor EPDCCH, the UE may assume the antenna ports 0-3, 107-110 of the serving cell are quasi co-located with respect to Doppler shift, Doppler spread, average delay, and delay spread.

For a given serving cell, if the UE is configured via higher layer signalling to receive PDSCH data transmissions according to transmission mode 10, and if the UE is configured to monitor EPDCCH, and if the UE is configured by higher layers to decode PDSCH according to quasi co-location Type-A, for each EPDCCH-PRB-set the UE may assume the antenna ports 0-3, 107-110 of the serving cell are quasi co-located with respect to Doppler shift, Doppler spread, average delay, and delay spread.

For a given serving cell, if the UE is configured via higher layer signalling to receive PDSCH data transmissions according to transmission mode 10, and if the UE is configured to monitor EPDCCH, and if the UE is configured by higher layers to decode PDSCH according to quasi co-location Type-B, for each EPDCCH-PRB-set the UE may assume antenna ports 15-22 corresponding to the higher layer parameter qcl-CSI-RS-ConfigNZPId-r11 and antenna ports 107-110 are quasi co-located with respect to Doppler shift, Doppler spread, average delay, and delay spread.

Moreover, if the mobile station device is configured with a subframe configuration (for example subframe type indication, Uplink-Downlink configuration and/or EPDCCH subframe pattern) the quasi co-location assumption can be determined depending on the subframe indicated by the subframe configuration.

The resource element mapping assumption and the quasi co-location assumption can determined depending on the parameter set indicated by the higher layer parameter Re-MappingQCL-ConfigListId-r12. For example, when several higher layer parameters Re-MappingQCL-ConfigListId-r12 are configured, each assumption for the resource element mapping and the quasi co-location is associated with each parameter Re-MappingQCL-ConfigListId-r12. For example, when one higher layer parameters Re-MappingQCL-ConfigListId-r12 is configured, each assumption for the resource element mapping and the quasi co-location is determined by the parameter Re-MappingQCL-ConfigListid-r12 and other parameter.

Following the resource element mapping assumption flow chart, the resource element mapping is performed according to the condition “subframe type” (legacy (condition 1) or flexible (condition 2)). Resource element mapping is performed using the parameter set indicated by re-MappingQCLConfigListId-r12 in a subframe configured for legacy downlink transmission (resource element mapping assumption 1). Resource element mapping is performed using the parameter set indicated by re-MappingQLConfigListId-r12 in a subframe configured as flexible subframe, with the exception of the parameters related to CRS. In a flexible subframe the base station device and the mobile station can assume that CRS is not present, and therefore the resource element mapping is not performed around it (resource element mapping assumption B).

Alternatively the flexible subframes can be built with CRS or without them. The presence of CRS in the flexible subframes is signaled implicitly and/or explicitly. In this case the mobile station device performs resource element mapping based on the condition “CRS configuration of the flexible subframes”.

The quasi co-location related parameter pdsch-Start-r11 has its reserved bit defined as ‘n0’ for starting on symbol 0. This parameter complements startSymbol-r12 to cover all transmission modes.

In another example, the eCSS related configuration is given as an addition to the legacy EPDCCH-Config-r11. In that case the StartSymbol-r11 cannot be initialized with the value 0. A special set EPDCCH-eCSS-setConfig-r12 is defined in which the parameters related to the eCSS are given. A special parameter is defined in the added eCSS parameter set that indicates the use of the OFDM symbol 0. In that case the mobile station device also monitors the eUSS from the symbol 0.

Alternatively, subframePatternConfig-r12 can be configured to contain two subframePattern-r11 elements. The first one is used to configure the monitoring of the eUSS in the marked subframes by the mobile station device. The second one is used to configure the monitoring of the eCSS in the marked subframes by the mobile station device.

In another embodiment of the invention the element re-MappingQCL-ConfigListId-r12 includes two quasi co-location indexes.

For the legacy subframes in which the eCSS is configured (condition 1) the resource element mapping is performed according to the parameter set given by the first re-MappingQCL-ConfigList-r12 index (resource element mapping assumption 1). For the flexible subframes in which the eCSS is configured (condition 2) the resource element mapping is performed according to the parameter set given by the second re-MappingQCL-ConfigList-r12 (resource element mapping assumption 2).

Following the quasi co-location assumption flow chart in the case the quasi co-location is defined as type A, the CRS antenna ports (0-3) and the DMRS antenna ports (107-110) can be considered quasi co-located.

In the case the quasi co-location is defined as type B it depends on the subframe type (condition). In legacy subframes (condition 1), the CSI-RS antenna ports (15-22) corresponding to the parameter qcl-CSI-RS-ConfigNZPId in the parameter set referenced by the first re-MappingQCL-ConfigList-r12 can be considered quasi co-located with the DMRS antenna ports (quasi co-location assumption 1). In flexible subframes (condition 2), the CSI-RS antenna ports corresponding to the parameter qcl-CSI-RS-ConfigNZPId in the parameter set referenced by the second re-MappingQCL-ConfigList-r12 can be considered quasi co-located with the DMRS antenna ports (quasi co-location assumption 2).

In another embodiment of the invention a plurality of paired subframePattern-r11 and re-MappingQCL-ConfigListId-r12 are transmitted. For example, a pair can be sent indicating the subframes for which ePDCCH is transmitted under a QCL assumption (including resource element mapping), while another pair can be sent referring to different subframes in which ePDCCH is transmitted under a different QCL assumption.

This case can be made available only for TM10, or alternatively it can be made available for all transmission modes to leverage the configuration pairing of the subframe mapping and the quasi co-location parameter set (which includes resource element mapping parameters).

In the case the quasi co-location is defined as type A, the CRS antenna ports and the DMRS antenna ports can be considered quasi co-located. In the case the quasi co-location is defined as type B, for each pair of subframePattern-r11 and re-MappingQCL-ConfigListId-r12 the CSI-RS corresponding to the parameter qct-CSI-RS-ConfigNZPId in the parameter set referenced by re-MappingQCL-ConfigList-r12 can be considered quasi co-located with the DMRS port.

In this case the condition clause is the pair of subframePattern-r11 and re-MappingQCL-ConfigListId-r12 that is chosen. In this case the number of conditions is not constrained to two, there are as many conditions as resource element mapping/quasi co-location assumption pairs.

In any of the previous examples, the eCSS can be configured in a separate ePDCCH-set to that of the eUSS. The mobile station devices monitor for eUSS in the ePDCCH-sets defined for eUSS and for eCSS in the ePDCCH-sets defined for eCSS.

Alternatively, the eCSS can be included in either or all of the ePDCCH-PRB-sets defined for eUSS. The mobile station devices monitor all the ePDCCH-PRB-sets for eUSS and eCSS.

Alternatively, the eCSS can only be configured for one of the ePDCCH-sets. The mobile station devices monitor eUSS in all the ePDCCH-PRB-sets, and eCSS in the configured ePDCCH-PRB-set.

Alternatively, the ECCEs of one of the ePDCCH-PRB-sets can be split for eCSS and eUSS operation. For example, the first half of the ECCEs of ePDCCH-PRB-set 0 are configured for eCSS and the second half of the ECCEs are configured for eUSS.

Alternatively, the base station device allocates the ECCEs following a given order, allocating the ECCEs corresponding to the eCSS in the first half of the ECCEs of the ePDCCH-PRB-set and the ECCEs corresponding to the eUSS in the second half of the ECCEs of the ePDCCH-PRB-set. The mobile station devices monitor the first possible instance of eCSS for each aggregation level, and skip the blind decoding of the rest of the options if the attempts were unsuccessful.

In another embodiment of the invention the eCSS is distributed between multiple ePDCCH-PRB-sets. All ePDCCH-PRB-sets have the same size. For example, the eCSS occupies the first half of the ECCEs of each ePDCCH-PRB-set and the eUSS occupies the second half of the ECCEs of each ePDCCH-PRB-set.

In the preceding examples the direction of the flexible subframes is considered to be implicitly decided by the mobile station devices. A flexible subframe for which the mobile station device has an uplink grant is considered an uplink subframe, and no monitoring is performed. Otherwise the mobile station device cannot know if the flexible subframe is uplink or downlink, and therefore monitors the appropriate search spaces. This is one example, and is not the only method of operation that can be applied. In another case the base station device transmits an RRC configuration message indicating the direction of the flexible subframes. In another case this information is transmitted for each subframe in the PDCCH, for example in a common message.

A program operated in the base station device and the mobile station devices according to the present invention may be a program (program causing a computer to function) for controlling a CPU (Central Processing Unit) or the like so as to realize the functions of the above-described embodiments according to the present invention. The information handled in these devices is temporarily stored in a RAM (Random Access Memory) during processing of the information, is then stored in various kinds of ROMs such as a flash ROM (Read Only Memory) or an HDD (Hard Disk Drive), and is read out, corrected, or written by the CPU as necessary.

Part of the mobile station devices and the base station device according to the above-described embodiments may be implemented by a computer. In that case, a program for implementing this control function may be recorded on a computer-readable recording medium, and a computer system may be caused to read and execute the program recorded on the recording medium.

Here, the “computer system” is a computer system included in each of the mobile station devices or the base station device, and includes hardware such as an OS and peripheral devices. The “computer-readable recording medium” is a portable medium such as a flexible disk, a magneto-optical disk, a ROM, or a CD-ROM, or a storage device such as a hard disk included in the computer system.

Furthermore, the “computer-readable recording medium” may also include an object that dynamically holds a program for a short time, such as a communication line used to transmit the program via a network such as the Internet or a communication line such as a telephone line, and an object that holds a program for a certain period of time, such as a volatile memory in a computer system serving as a server or a client in this case. Also, the above-described program may implement some of the above-described functions, or may be implemented by combining the above-described functions with a program which has already been recorded on a computer system.

Furthermore, part or whole of the mobile station devices and the base station device in the above-described embodiment may be implemented as an LSI, which is typically an integrated circuit, or as a chip set. The individual functional blocks of the mobile station devices and the base station device may be individually formed into chips, or some or all of the functional blocks may be integrated into a chip. The method for forming an integrated circuit is not limited to LSI, and may be implemented by a dedicated circuit or a general-purpose processor. In a case where the progress of semiconductor technologies produces an integration technology which replaces an LSI, an integrated circuit according to the technology may be used.

While some embodiments of the present invention have been described in detail with reference to the drawings, specific configurations are not limited to those described above, and various design modifications and so forth can be made without deviating from the gist of the present invention.

### REFERENCE SIGNS LIST

1 Base station device
2 Mobile station device
3 PDCCH/ePDCCH
4 Downlink data transmission
5 Physical Uplink Control Channel
101 Higher layer processing unit
1011 Wireless resource management unit
1013 Subframe configuration unit
1015 Scheduling unit
1017 CST report management unit
103 Control unit
105 Reception unit
1051 Decoding unit
1053 Demodulation unit
1055 Demultiplexing unit
1057 Radio reception unit
1059 Channel estimation unit
107 Transmission unit
1071 Coding unit
1073 Modulation unit
1075 Multiplexing unit
1077 Radio transmission unit
1079 Uplink reference signal generation unit
109 Antenna unit
301 Higher layer processing unit
3011 Wireless resource management unit
3013 Subframe configuration unit
3015 Scheduling unit
3017 CSI report management unit
303 Control unit
305 Reception unit
3051 Decoding unit
3053 Demodulation unit
3055 Demultiplexing unit
3057 Radio reception unit
3059 Channel estimation unit
307 Transmission unit
3071 Coding unit
3073 Modulation unit
3075 Multiplexing unit
3077 Radio transmission unit
3079 Uplink reference signal generation unit
309 Antenna unit

1-56. (canceled)

57. A terminal comprising:
a higher layer processor configured to configure a parameter for Enhanced Interference Management and Traffic Adaptation (eIMTA) for a serving cell, wherein
one zero-power Channel State Information-Reference Signal (CSI-RS) resource configuration is configured for the serving cell in a case that the parameter for the eIMTA is not configured, and
two zero-power CSI-RS resource configurations are configured for the serving cell in a case that the parameter for the eIMTA is configured.

58. The terminal according to claim 57, wherein
the one zero-power CSI-RS resource configuration or the two zero-power CSI-RS resource configurations are used for determining a resource element mapping of an enhanced physical downlink control channel.

59. The terminal according to claim 57, wherein
one of the two zero-power CSI-RS resource configurations is configured in a case that the parameter for eIMTA is configured and two subframe sets are configured for the serving cell.

60. The terminal according to claim 59, wherein
the one of the two zero-power CSI-RS resource configurations indicates a rate matching parameter.

61. The terminal according to claim 57, wherein
an enhanced physical downlink control channel is not mapped to resource elements based on the one zero-power CSI-RS resource configuration or the two zero-power CSI-RS resource configurations.

62. A communication method for a terminal device, the communication method comprising:
configuring a parameter for Enhanced Interference Management and Traffic Adaptation (eIMTA) for a serving cell, wherein
one zero-power Channel State Information-Reference Signal (CSI-RS) resource configuration is configured for the serving cell in a case that the parameter for the eIMTA is not configured, and
two zero-power CSI-RS resource configurations are configured for the serving cell in a case that the parameter for the eIMTA is configured.

63. The communication method according to claim 62, wherein
the one zero-power CSI-RS resource configuration or the two zero-power CSI-RS resource configurations are used for determining a resource element mapping of an enhanced physical downlink control channel.

64. The communication method according to claim 62, wherein
one of the two zero-power CSI-RS resource configurations is configured in a case that the parameter for eIMTA is configured and two subframe sets are configured for the serving cell.

65. The communication method according to claim 64, wherein
the one of the two zero-power CSI-RS resource configurations indicates a rate matching parameter.

66. The communication method according to claim 62, wherein
an enhanced physical downlink control channel is not mapped to resource elements based on the one zero-power CSI-RS resource configuration or the two zero-power CSI-RS resource configurations.

67. An integrated circuit mountable on a terminal, the integrated circuit comprising:
a higher layer processor configured to configure a parameter for Enhanced Interference Management and Traffic Adaptation (eIMTA) for a serving cell, wherein
one zero-power Channel State Information-Reference Signal (CSI-RS) resource configuration is configured for the serving cell in a case that the parameter for the eIMTA is not configured, and
two zero-power CSI-RS resource configurations are configured for the serving cell in a case that the parameter for the eIMTA is configured.

68. The integrated circuit according to claim 67, wherein
the one zero-power CSI-RS resource configuration or the two zero-power CSI-RS resource configurations are used for determining a resource element mapping of an enhanced physical downlink control channel.

69. The integrated circuit according to claim 67, wherein
one of the two zero-power CSI-RS resource configurations is configured in a case that the parameter for eIMTA is configured and two subframe sets are configured for the serving cell.

70. The integrated circuit according to claim 69, wherein
the one of the two zero-power CSI-RS resource configurations indicates a rate matching parameter.

71. The integrated circuit according to claim 67, wherein
an enhanced physical downlink control channel is not mapped to resource elements based on the one zero-power CSI-RS resource configuration or the two zero-power CSI-RS resource configurations.
